(19) United States
(12) Patent Application Publication
(10) Pub. No.: US 2024/0373215 A1
(43) Pub. Date: Nov. 7, 2024

(54) SECURITY CONFIGURATION UPDATE IN COMMUNICATION NETWORKS

(71) Applicant: ZTE Corporation, Shenzhen (CN)

(72) Inventors: Zhen XING, Shenzhen (CN); Shilin You, Shenzhen (CN); Jigang Wang, Shenzhen (CN); Yuze Liu, Shenzhen (CN); Jin Peng, Shenzhen (CN); Zhaoji Lin, Shenzhen (CN)

(73) Assignee: ZTE Corporation, Shenzhen (CN)

(21) Appl. No.: 18/649,146

(22) Filed: Apr. 29, 2024

Related U.S. Application Data
(63) Continuation of application No. PCT/CN2022/075162, filed on Jan. 30, 2022.

(51) Int. Cl. H04W 12/0433; H04W 12/041; H04W 12/06

(52) U.S. Cl. CPC H04W 12/0433; H04W 12/041; H04W 12/06

(57) ABSTRACT

This disclosure generally relates to updating and synchronizing security configuration in communication networks. Performed by a wireless device in a wireless network, the method includes receiving, from a first network element hosting an application function, a first message comprising at least one of: an Authentication and Key Management for Applications (AKMA) anchor key identifier associated with the wireless device; an authentication method indicator indicating an authentication method; or a set of parameters associated with the authentication method.

### TECHNICAL FIELD

This disclosure relates to updating and synchronizing security configuration in communication networks.

### BACKGROUND

In a communication network, the mutual authentication of a User Equipment (UE) and the communication network may be performed to allow only authenticated UE and the authenticated communication network to communicate with each other. Application Function (AF) entities may provide various application services to the UE once authenticated. Efficient and robust authentication mechanism involving various network elements is critical to provide secure communication between Application Function entity and the UE, and to protect the credentials of the UE and the Application Function entity.

### SUMMARY

This disclosure relates to updating and synchronizing security configuration in communication networks, and in particular, to refreshing security keys and other security parameters in various network entities such as Application Function, UE, etc.

In one embodiment, the present disclosure describes a method for wireless communication. Performed by a wireless device in a wireless network, the method includes receiving, from a first network element hosting an application function, a first message comprising at least one of: an Authentication and Key Management for Applications (AKMA) anchor key identifier associated with the wireless device; an authentication method indicator indicating an authentication method; or a set of parameters associated with the authentication method.

In another embodiment, the present disclosure describes a method for wireless communication. Performed by a first network element in a wireless network in a wireless network, the first network element hosting an AKMA anchor function, and the method includes: receiving a first message requesting updated security related information associated with a wireless device in the wireless network, the first message comprising at least one of: an identifier of the wireless device; or a first AKMA anchor key identifier associated with the wireless device; deriving a currently valid AKMA application key based on a currently valid AKMA anchor key associated with the wireless device; obtaining updated security related information associated with the wireless device based on at least the currently valid AKMA application key; and transmitting, to a second network element hosting an application function, a second message as a response to the first message, the second message comprising the updated security related information associated with the wireless device.

In another embodiment, the present disclosure describes a method for wireless communication. Performed by a first network element in a wireless network in a wireless network, the first network element hosting an application function, and the method includes: transmitting a first message requesting updated security related information associated with a wireless device in the wireless network, the first message comprising at least one of: an identifier of the wireless device; or a first AKMA anchor key identifier associated with the wireless device; and receiving, from a second network element hosting an AKMA anchor function, a second message as a response to the first message, the second message comprising the updated security related information associated with the wireless device.

In another embodiment, a network element or wireless device comprising a processor and a memory is disclosed. The processor may be configured to read computer code from the memory to implement any of the methods above.

In yet another embodiment, a computer program product comprising a non-transitory computer-readable program medium with computer code stored thereupon is disclosed. The computer code, when executed by a processor, may cause the processor to implement any one of the methods above.

The above embodiments and other aspects and alternatives of their implementations are explained in greater detail in the drawings, the descriptions, and the claims below.

### BRIEF DESCRIPTION OF THE DRAWINGS

FIG. 1 shows an exemplary communication network including various terminal devices, a carrier network, data network, and service applications.

FIG. 2 shows exemplary network functions or network nodes in a communication network.

FIG. 3 shows exemplary network functions or network nodes in a wireless communication network.

FIG. 4 shows an exemplary network model for an Authentication and Key Management for Applications (AKMA) framework.

FIG. 5 shows an exemplary key hierarchy under the AKMA framework.

FIGS. 6-11 show various exemplary logic flows for updating various security configuration in the Application Function and UE.

FIG. 12 shows an exemplary logic flow for pushing AKMA security configuration to the UE.

### DETAILED DESCRIPTION

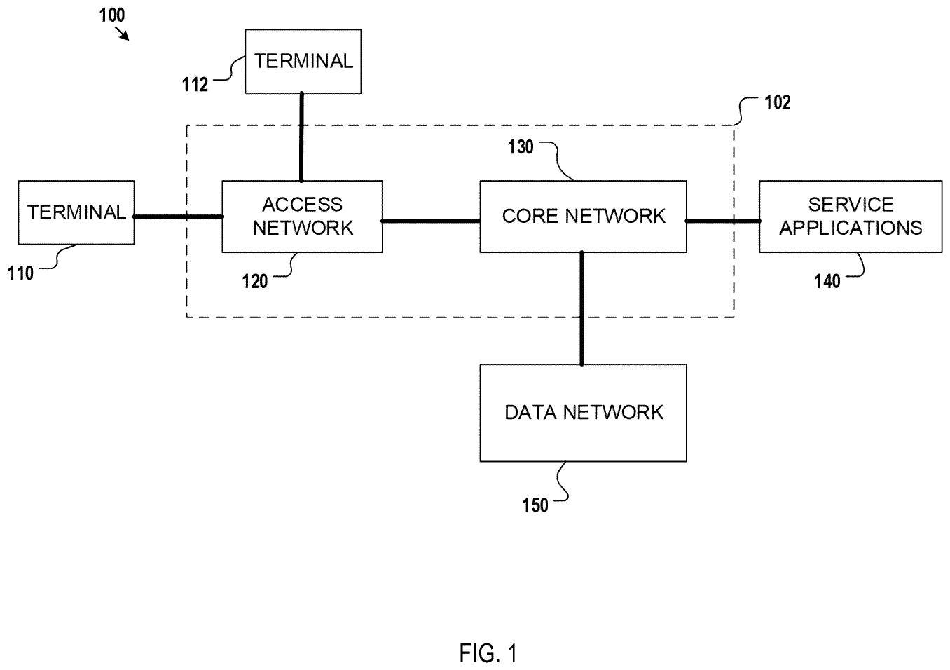

An exemplary communication network, shown as 100 in FIG. 1, may include terminal devices 110 and 112, a carrier network 102, various service applications 140, and other data networks 150. The carrier network 102, for example, may include access networks 120 and a core network 130. The carrier network 102 may be configured to transmit voice, data, and other information (collectively referred to as data traffic) among terminal devices 110 and 112, between the terminal devices 110 and 112 and the service applications 140, or between the terminal devices 110 and 112 and the other data networks 150. Communication sessions and corresponding data paths may be established and configured for such data transmission. The Access networks 120 may be configured to provide terminal devices 110 and 112 network access to the core network 130. The Access network 120 may, for example, support wireless access via radio resources, or wireline access. The core network 130 may include various network nodes or network functions configured to control the communication sessions and perform network access management and data traffic routing. The service applications 140 may be hosted by various application servers that are accessible by the terminal devices 110 and 112 through the core network 130 of the carrier network 102. A service application 140 may be deployed as a data network outside of the core network 130. Likewise, the other data networks 150 may be accessible by the terminal devices 110 and 112 through the core network 130 and may appear as either data destination or data source of a particular communication session instantiated in the carrier network 102.

The core network 130 of FIG. 1 may include various network nodes or functions geographically distributed and interconnected to provide network coverage of a service region of the carrier network 102. These network nodes or functions may be implemented as dedicated hardware network elements. Alternatively, these network nodes or functions may be virtualized and implemented as virtual machines or as software entities. A network node may each be configured with one or more types of network functions. These network nodes or network functions may collectively provide the provisioning and routing functionalities of the core network 130. The term “network nodes” and “network functions” are used interchangeably in this disclosure.

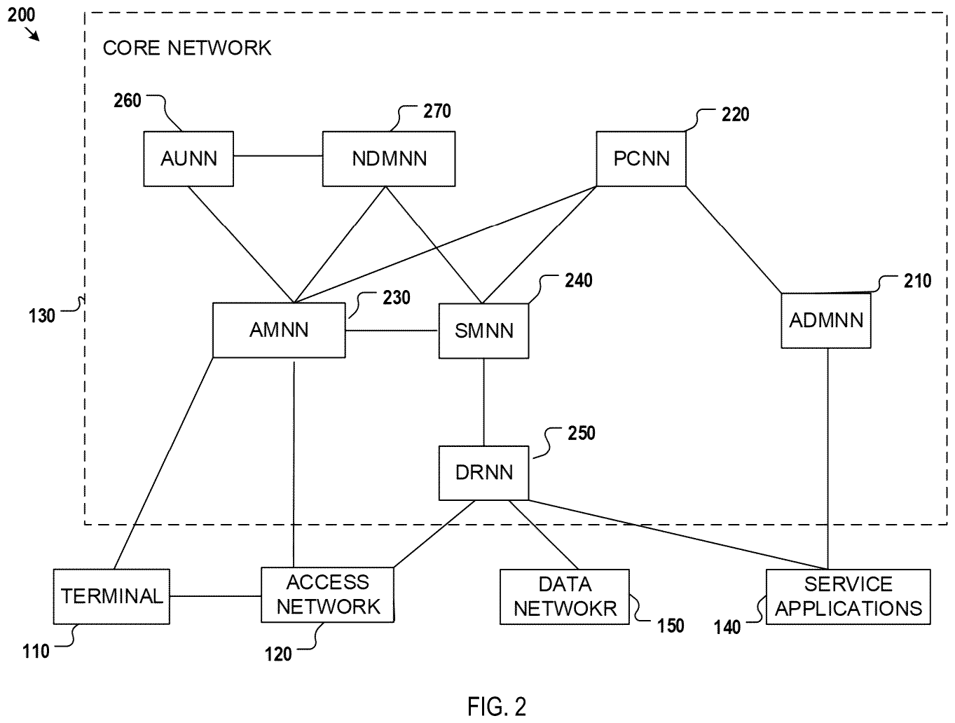

FIG. 2 further shows an exemplary division of network functions in the core network 130 of a communication network 200. While only single instances of network nodes or functions are illustrated in FIG. 2, those having ordinary skill in the art readily understand that each of these network nodes may be instantiated as multiple instances of network nodes that are distributed throughout the core network 130. As shown in FIG. 2, the core network 130 may include but is not limited to network nodes such as access management network node (AMNN) 230, authentication network node (AUNN) 260, network data management network node (NDMNN) 270, session management network node (SMNN) 240, data routing network node (DRNN) 250, policy control network node (PCNN) 220, and application data management network node (ADMNN) 210. Exemplary signaling and data exchange between the various types of network nodes through various communication interfaces are indicated by the various solid connection lines in FIG. 2. Such signaling and data exchange may be carried by signaling or data messages following predetermined formats or protocols.

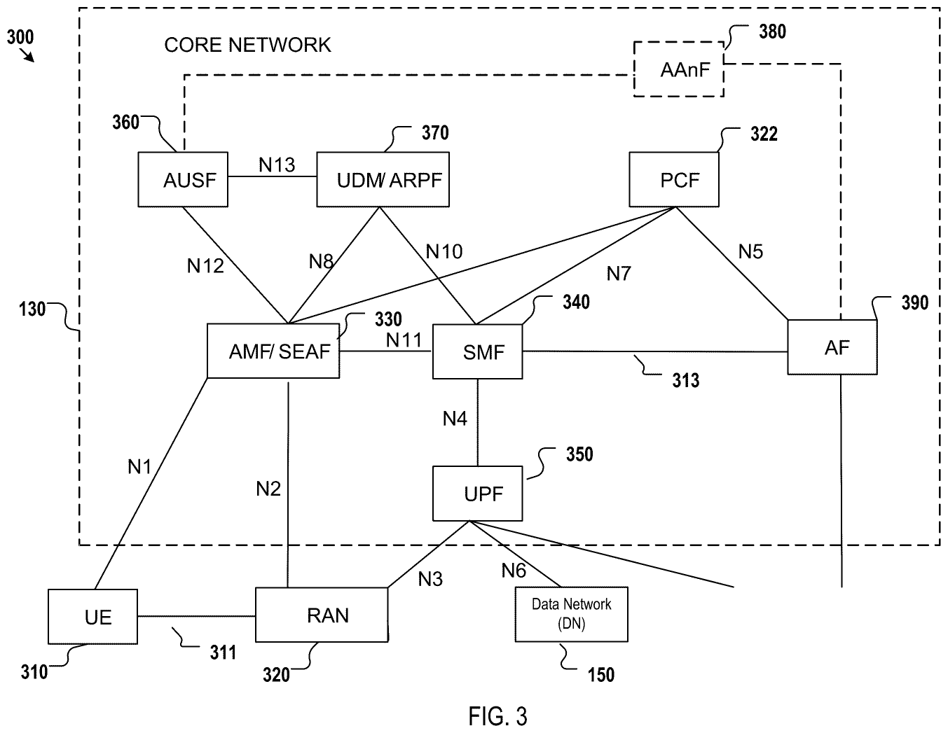

The implementations described above in FIGS. 1 and 2 may be applied to both wireless and wireline communication systems. FIG. 3 illustrates an exemplary cellular wireless communication network 300 based on the general implementation of the communication network 200 of FIG. 2. FIG. 3 shows that the wireless communication network 300 may include user equipment (UE) 310 (functioning as the terminal device 110 of FIG. 2), radio access network (RAN) 320 (functioning as the access network 120 of FIG. 2), data network (DN) 150, and core network 130 including access management function (AMF) 330 (functioning as the AMNN 230 of FIG. 2), session management function (SMF) 340 (functioning as the SMNN 240 of FIG. 2), application function (AF) 390 (functioning as the ADMNN 210 of FIG. 2), user plane function (UPF) 350 (functioning as the DRNN 250 of FIG. 2), policy control function 322 (functioning as the PCNN 220 of FIG. 2), authentication server function (AUSF) 360 (functioning as the AUNN 260 of FIG. 2), and universal data management (UDM) function 370 (functioning as the UDMNN 270 of FIG. 2). Again, while only single instances for some network functions or nodes of the wireless communication network 300 (the core network 130 in particular) are illustrated in FIG. 3, those of ordinary skill in the art readily understand that each of these network nodes or functions may have multiple instances that are distributed throughout the wireless communication network 300. While the AF 390 is depicted as part of the core network 130 in FIG. 3, they may be considered as associated with particular service applications 140 and may be considered as being outside of the core network 140.

In FIG. 3, the UE 310 may be implemented as various types of mobile devices that are configured to access the core network 130 via the RAN 320. The UE 310 may include but is not limited to mobile phones, laptop computers, tablets, Internet-Of-Things (IoT) devices, distributed sensor network nodes, wearable devices, and the like. The UE may also be Multi-access Edge Computing (MEC) capable UE that supports edge computing. The RAN 320 for example, may include a plurality of radio base stations distributed throughout the service areas of the carrier network. The communication between the UE 310 and the RAN 320 may be carried in over-the-air (OTA) radio interfaces as indicated by 311 in FIG. 3.

Continuing with FIG. 3, the UDM 370 may form a permanent storage or database for user contract and subscription data. The UDM may further include an authentication credential repository and processing function (ARPF, as indicated in 370 of FIG. 3) for storage of long-term security credentials for user authentication, and for using such long-term security credentials as input to perform computation of encryption keys as described in more detail below. To prevent unauthorized exposure of UDM/ARPF data, the UDM/ARPF 370 may be located in a secure network environment of a network operator or a third-party.

The AMF/SEAF 330 may communicate with the RAN 320, the SMF 340, the AUSF 360, the UDM/ARPF 370, and the PCF 322 via communication interfaces indicated by the various solid lines connecting these network nodes or functions. The AMF/SEAF 330 may be responsible for UE to non-access stratum (NAS) signaling management, and for provisioning registration and access of the UE 310 to the core network 130 as well as allocation of SMF 340 to support communication need of a particular UE. The AMF/SEAF 330 may be further responsible for UE mobility management. The AMF may also include a security anchor function (SEAF, as indicated in 330 of FIG. 3) that, as described in more detail below, and interacts with AUSF 360 and UE 310 for user authentication and management of various levels of encryption/decryption keys. The AUSF 360 may terminate user registration/authentication/key generation requests from the AMF/SEAF 330 and interact with the UDM/ARPF 370 for completing such user registration/authentication/key generation.

The SMF 340 may be allocated by the AMF/SEAF 330 for a particular communication session instantiated in the wireless communication network 300. The SMF 340 may be responsible for allocating UPF 350 to support the communication session and data flows therein in a user data plane and for provisioning/regulating the allocated UPF 350 (e.g., for formulating packet detection and forwarding rules for the allocated UPF 350). Alternative to being allocated by the SMF 340, the UPF 350 may be allocated by the AMF/SEAF 330 for the particular communication session and data flows. The UPF 350 allocated and provisioned by the SMF 340 and AMF/SEAF 330 may be responsible for data routing and forwarding and for reporting network usage by the particular communication session. For example, the UPF 350 may be responsible for routing end-end data flows between UE 310 and the DN 150, between UE 310 and the service applications 140. The DN 150 and the service applications 140 may include but are not limited to data network and services provided by the operator of the wireless communication network 300 or by third-party data network and service providers.

The PCF 322 may be responsible for managing and providing various levels of policies and rules applicable to a communication session associated with the UE 310 to the AMF/SEAF 330 and SMF 340. As such, the AMF/SEAF 330, for example, may assign SMF 340 for the communication session according to policies and rules associated with the UE 310 and obtained from the PCF 322. Likewise, the SMF 340 may allocate UPF 350 to handle data routing and forwarding of the communication session according to policies and rules obtained from the PCF 322.

While FIGS. 1-3 and the various exemplary implementations described below are based on cellular wireless communication networks, the scope of this disclosure is not so limited and the underlying principles are applicable to other types of wireless and wireline communication networks.

Network identity and data security in the wireless communication network 300 of FIG. 3 may be managed via user authentication processes provided by the AMF/SEAF 330, the AUSF 360, and the UDM/ARPF 370. In particularly, the UE 310 may first communicate with AMF/SEAF 330 for network registration and may then be authenticated by the AUSF 360 according to user contract and subscription data in the UDM/ARPF 370. Communication sessions established for the UE 310 after user authentication to the wireless communication network 300 may then be protected by the various levels of encryption/decryption keys. The generation and management of the various keys may be orchestrated by the AUSF 360 and other network functions in the communication network 300.

### AKMA Framework

In the wireless communication network, the Application Function (AF) may provide application service to a UE. AF may or may not resides in of the core network. In certain scenarios, the AF may need to push a message on its own initiative to the UE (e.g., the AF may push various notification to the UE according to the service subscribed to the AF by the UE). In further disclosure below, various embodiments are disclosed to facilitate the AF to securely push the message to the UE under an Authentication and Key Management for Applications (AKMA) framework. The AKMA framework may be based on various authentication procedures such as the 5G Authentication and Key Agreement (5G-AKA) method, the Extensible Authentication Protocol Method for 3rd Generation Authentication and Key Agreement (EAP-AKA′) method, the Extensible Authentication Protocol-Transport Layer Security (EAP-TLS) method, or the like.

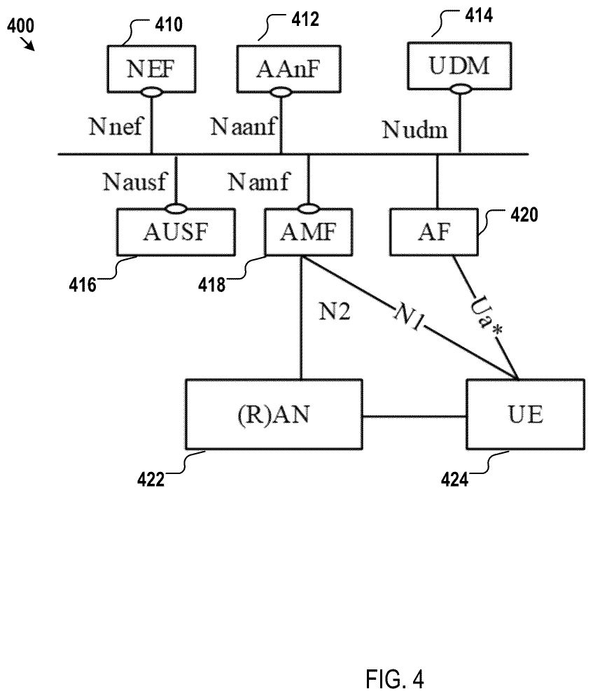

FIG. 4 illustrates an exemplary network model 400 for implementing an AKMA framework. This model includes various network elements. Each network element may be implemented as a physical entity, or a logical entity providing a particular set of network functions. A logical entity may be based on software, hardware, firmware, of any combination thereof. For example, a logical entity may include a server providing the function. For another example, a logical entity may be implemented based on cloud-based service or platform, such as Software as a service (SaaS), Platform as a service (PaaS), etc.

The AKMA Anchor Function (AAnF) 412 provides a security anchor function in the Home Public Land Mobile Network (HPLMN). The AAnF stores the AKMA Anchor Key (K_{AKMA}) for AKMA service, which is received from the Authentication Server Function (AUSF) 416 after the UE 424 completes a successful primary authentication. The AAnF may also generate the key material to be used between the UE and the Application Function (AF) 420 and maintains UE AKMA context (also referred to as AKMA security context).

The AF 420 may provide application service to the UE. Under the AKMA framework, the AF may request for its AKMA Application Key, denoted as K_{AF}, from the AAnF using an identifier for the K_{AKMA}. The identifier may include an AKMA Key Identifier (A-KID). The AAnF may only provide the K_{AF} to the AF after the AF is authenticated and authorized by the operator network. The AF may be located inside or outside the operator's network. In this disclosure, for simplicity, the AKMA Application Key (K_{AF}) may also be referred to as the AF key.

The Network Exposure Function (NEF) 410 may be configured to enable and authorize external AFs to access the AKMA service and forward the AKMA service request towards the AAnF. The NEF may also perform the AAnF selection in case there are multiple AAnFs.

The AUSF 416 may provide the Subscription Permanent Identifier (SUPI) and AKMA key material (e.g., A-KID, K_{AKMA}) of the UE to the AAnF. The AUSF may also perform the AAnF selection.

The UDM may store AKMA subscription data of the subscriber (or the UE subscribed to the wireless communication network).

Referring to FIG. 4, various interfaces may be involved in the AKMA framework. These interfaces may include Nnef, Naanf, Nudm, Uausf, and Namf and may be referred to as Service Based Interface (SBI), as each interface corresponds to a service provided by a network element. For example, Nnef represnets the SBI utilized by the NEF; Naanf represents the SBI utilized by the AAnF; and Nudm represents the SBI utilized by the UDM. The network elements may interact with each other via the various SBIs. The SBI may provide security protection. For example, the SBI may be confidentiality, integrity and replay protected.

FIG. 4 shows the implementation where the AAnF is deployed as a standalone function. Other deployment options may be chosen. For example, the AAnF may be co-located with the AUSF, or the AAnF may be co-located with the NEF.

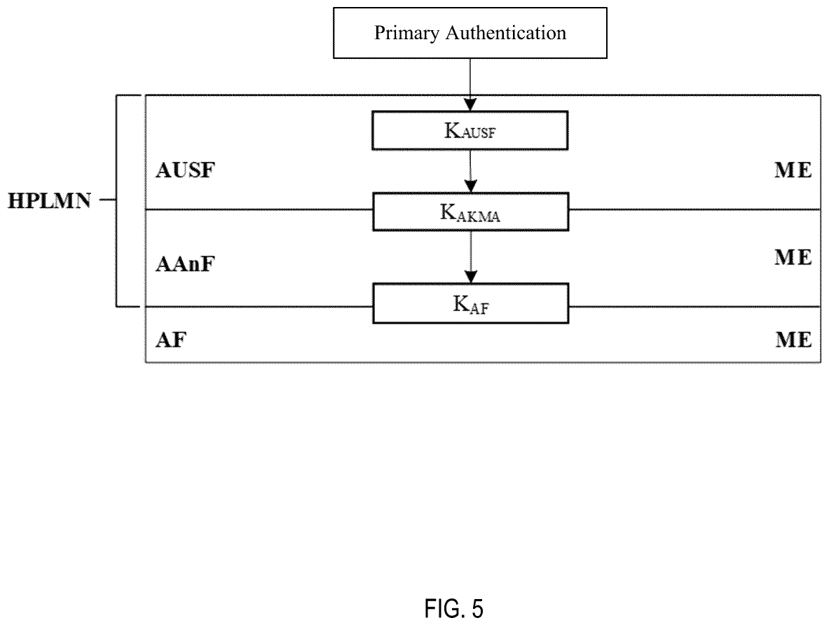

Under the AKMA framework, there may be various keys involved, and these keys may be organized in a hierarchical structure as shown in FIG. 5. The example key hierarchy of FIG. 5 may include the following keys at different level: K_{AUSF}, K_{AKMA}, and K_{AF}. These keys may be derived and stored in parallel on both the network side and the Mobile Equipment (ME) side. The ME refers to a portion of a UE along with other portions of UE such as a Universal Subscriber Identity Module (USIM).

After a successful primary authentication between the UE and the wireless communication network (e.g., UE authenticated by the operator), the AUSF and/or the UE may derive the K_{AUSF} based on an Integrity Key (IK) of the UE, and a Cipher Key (CK) of the UE. AUSF may alternatively derive the K_{AUSF} based on a transformation of the Integrity Key (denoted as IK′) of the UE, and a transformation of the Cipher Key (denoted as CK′) of the UE.

Based on the K_{AUSF}, the ME and the AUSF may each derive the K_{AKMA} based on the K_{AUSF}, and the SUPI of the UE, by using a Key Derivation Function (KDF).

Then based on the K_{AKMA}, the ME and the AAnF may each derive the K_{AF} based on the K_{AKMA}, and an identifier of the AF, also similarly by using a KDF. It is to be noted that a UE may store multiple K_{AF}, each corresponding to an AF. Likewise, an AF may store multiple K_{AF}, each corresponding to a UE.

The various keys described herein may each have a lifetime. For example, the K_{AKMA} may be refreshed until the next successful primary authentication. For another example, the K_{AF} may be provisioned with a lifetime, for example, by the AAnF. In some embodiments, the lifetime of a key may be associated with a timer, such that the timer is started once a key is commissioned, and once the timer expires, the key is refreshed.

In a wireless communication network, a UE may subscribe to various application services from an AF. When invoking services provided by the AF, secure communication link needs to be established and maintained. The UE and the AF may each maintain a security configuration to support the secure communication link. The security configuration may include, for example, a K_{AF}. In certain adverse network condition, or due to a faulty network element, the security configuration may become invalid, stale, or even get lost. For example, the K_{AF} may become invalid or expired, or the security configuration may be out of sync between the AF and the UE. It is critical for the AF and/or the UE to take mitigation actions for recovering from this type of error conditions.

In this disclosure, various embodiments are disclosed for updating or refreshing security configuration in the AF and/or the UE. The security configuration may include the K_{AF}, key lifetime, authentication parameters, etc. Details including interactions between various network elements are described below.

### Embodiment 1: Key Refresh Using NEF

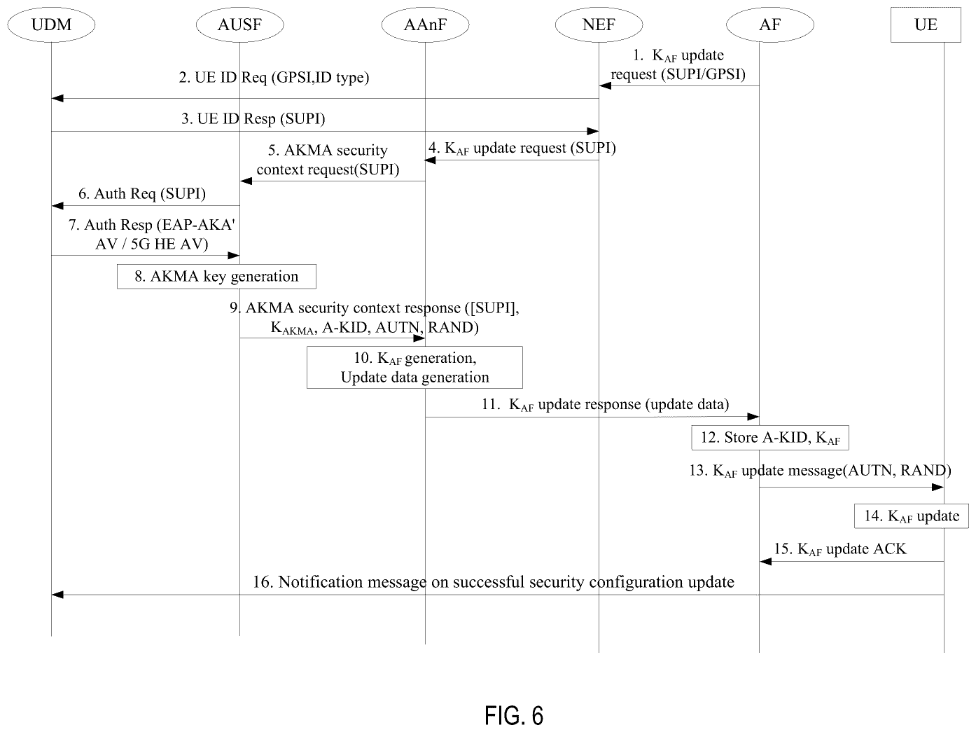

FIG. 6 shows exemplary steps for the AF to refresh security configuration including K_{AF} associated with a UE. The refreshed information is further synchronized to the UE.

In this embodiment, the AF does not have direct access to the AAnF, for example, if the AF is allocated outside of the core network (e.g., AUSF, UDM, etc.). As an example, the NEF is utilized as a relay to the core network.

With reference to FIG. 6, the exemplary steps are described in details below.

### Step 0

Step 0 is optional and is not shown in FIG. 6. In this step, the UE successfully performs a primary authentication with the core network and the UE is configured with valid security context.

### Step 1

The K_{AF} in the AF is expired or invalid, or the K_{AF} may be lost under a faulty condition. In order to refresh the K_{AF}, the AF may send a K_{AF} update request to the Network Exposure Function (NEF). The K_{AF} update request may include the identity of the UE, e.g., Generic Public Subscription Identifier (GPSI), SUPI, or 5G-GUTI of the UE. In one implementation, the GPSI may be used when the AF is located outside the operator's network. If SUPI is used in the request, step 2 and step 3 below may be skipped.

For secure communication between the AF and the UE, a security context (may also be referred to as a security configuration, an AKMA security context) may need to be set up on both sides. The security context may be based on the AKMA framework and may include an AKMA anchor key (or an ID of the AKMA anchor key (A-KID)) of the UE, and an AF key of the UE (corresponding to the particular AF). Alternatively, the security context may include a binding of the AKMA anchor key (or A-KID) of the UE and the AF key of the UE. This binding may be referred to as a Security Association (SA). As described earlier, in this disclosure, the AKMA anchor key of the UE and the AF key of the UE may be denoted as K_{AKMA} and K_{AF}, respectively. It is to be understood that for each AF, the UE may maintain a corresponding AF key. Likewise, on the AF side, the AF may maintain an AF key for each UE it serves.

### Steps 2-3

Upon receiving the K_{AF} update request message from the AF in step 1, if the identity of the UE in the request message is in the form of GPSI or another format other than SUPI, the NEF may retrieve the SUPI of the UE from the UDM. In particular, the NEF may send to the UDM a UE ID request which may include the GPSI and optionally an ID type indicator. The ID type indicator may indicate the ID type for the ID requested. For example, the ID type indicator may indicate the ID in the form of SUPI is requested. The UDM may reply with the SUPI of the UE in a UE ID response message in step 3.

### Step 4

The NEF sends a K_{AF} update request to the AAnF. The K_{AF} update request may include the SUPI of the UE.

### Step 5

The AAnF may then select an AUSF based on its local policy and send an AKMA Security Context Request to the selected AUSF. The AKMA Security Context Request may include the SUPI of the UE.

In one implementation, the AAnF may be provisioned with AUSF function, or the AAnF and the AUSF may be co-located. In this case, the AAnF may directly interact with the UDM to request the AKMA Security Context from the UDM.

In certain scenario, the AAnF may use the SUPI of the UE to check whether the security context associated with UE is readily available (e.g., the AAnF stores the security context locally). If yes, the AAnF may retrieve the A-KID from the security context and send the A-KID to the AF. The AF may then re-initiate the K_{AF} update request carrying the A-KID. Embodiments 3-6 covering the scenario in which the A-KID is carried in the K_{AF} update request will be described in later sections.

### Step 6

Upon receiving the AKMA Security Context Request from the AAnF, the AUSF may send an Authentication Request to the UDM. The Authentication Request may be used to request the AKMA security context and may include the SUPI of the UE.

### Step 7

The UDM (or ARPF) may determine the authentication method according to the UE subscription data of the UE. In one implementation, the UDM may retrieve the UE subscription data based on the SUPI of the UE.

If the authentication method is EAP-AKA′, the UDM may reply to the AUSF with an EAP-AKA′ Authentication Vector (AV). The EAP-AKA′ AV may include at least one of:
a random number (RAND), which may be used as a challenge;
an authentication token (AUTN), which may be used for proving the challenge's freshness and authenticity;
an expected response (XRES) to the challenge in an authentication procedure;
a transformation of the cipher key of the UE (transformed key denoted as CK′); or
a transformation of the integrity key of the UE (transformed key denoted as IK′).

The transformation of the cipher key and the integrity key may be based on a predetermined algorithm, such as a KDF.

If the authentication method is 5G AKA, the UDM may reply to the AUSF with a 5G Home Environment Authentication Vector (5G HE AV). The 5G HE AV may include at least one of:
a random number (RAND), which may be used as a challenge;
an authentication token (AUTN), which may be used for proving the challenge's freshness and authenticity;
an expected response (XRES*) to the challenge in an authentication procedure;
an AUSF key (K_{AUSF}) of the UE.

The reply message to the AUSF may further include an authentication method indicator, which indicates what authentication method is chosen for the UE (e.g., 5G AKA, EAP-AKA′, or EAP-TLS).

In one implementation, the reply message to the AUSF may further include a Routing Indicator (RID) of the UE.

### Step 8

Upon receiving the response from the UDM, depending on the authentication method, the AUSF may retrieve the AUSF key (K_{AUSF}) from the response message directly, or may need to derive or generate K_{AUSF}.

If the authentication method indicator indicates that EAP-AKA′ is used as the authentication method, the AUSF may derive K_{AUSF} based on CK′ and IK′.

If the authentication method indicator indicates that 5G AKA is used as the authentication method, the AUSF may retrieve K_{AUSF} from the response message directly. For example, K_{AUSF} may be part of the 5G HE AV.

Next, the AUSF may generate the AKMA Anchor Key (K_{AKMA}) and the A-KID based on K_{AUSF}.

In one implementation, K_{AKMA} may be derived by: K_{AKMA}=KDF (SUPI, K_{AUSF}). KDF refers to an exemplary Key Derivation Function. For example, the KDF may include HMAC-SHA-256 (256-bit Hash-based Message Authentication Code for Secure Hash Algorithm). When using HMAC-SHA-256, the output of the KDF may be a 256-bits key. In one implementation, the output key may further be truncated, for example, to 128 bits. When deriving K_{AKMA} using KDF as described above, SUPI of the UE may be used as a key, and K_{AUSF} may be used as an input.

As described above, A-KID may be used to identify K_{AKMA} of the UE. In one implementation, A-KID may be represented in a Network Access Identifier (NAI) format, i.e. username@realm. The username part may include the RID of the UE and an AKMA Temporary UE Identifier (A-TID) of the UE, and the realm part may include Home Network Identifier of the UE. In one implementation, A-TID may be derived based on K_{AUSF} using a KDF. For example, A-TID=KDF (K_{AUSF}, “AKMA”), i.e., the KDF uses string “AKMA” as the input, and K_{AUSF} as the key. The RID may be received from the UDM as part of the response message in step 7.

In one implementation, K_{AKMA} or A-KID derived in this step may be served as part of the AKMA context of the UE, which is described in detail in steps below.

### Step 9

As a response to the AKMA Security Context Request received from the AAnF in step 5, the AUSF may send a reply message to the AAnF. The reply message may include at least one of:
the random number (RAND) from the EAP-AKA′ AV or the 5G HE AV, depending on the selected authentication method;
an authentication token (AUTN) from the EAP-AKA′ AV or the 5G HE AV, depending on the selected authentication method;
the authentication method indicator; or
the AKMA context of the UE.

The AKMA context of the UE may include K_{AKMA} of the UE and A-KID identifying K_{AKMA}.

In one implementation, the reply message may further include the SUPI of the UE.

### Step 10

Upon receiving the AKMA context response message from the AUSF, the AAnF may derive the Application Key (K_{AF}) of the UE from K_{AKMA} of the UE. For example, the application key may be determined by K_{AF}=KDF (AF-ID, K_{AKMA}), where AF-ID is the identifier of the AF.

The AAnF may also generate or prepare updated (i.e., currently valid) security data to be sent to the AF in step below. In this disclosure, the term “currently valid” information may refer to “up-to-date” information, which is either under active serving configuration, or is targeted to be deployed in a serving configuration. The updated security data may include:
A-KID identifying the K_{AKMA} of the UE;
K_{AF} of the UE corresponding to the AF;
a lifetime of the AKMA security context related configuration information, e.g., a valid time period for the security key such as K_{AF};
the random number (RAND) from the EAP-AKA′ AV or the 5G HE AV, which is received by the AAnF in the step 9;
an authentication token (AUTN) from the EAP-AKA′ AV or the 5G HE AV, which is received by the AAnF in the step 9; or
the authentication method indicator.

### Step 11

Once the updated security data is generated or derived, the AAnF may send the updated security data to the AF, for example, via a K_{AF} update response message, which is a response message to the K_{AF} update request message in step 4 (and essentially step 1).

### Step 12

Based on the response message received in step 11, the AF may store A-KID and K_{AF} of the UE, as well as other security configuration information as seen in the updated security data described in step 10 above.

### Step 13

To ensure UE to be in sync with the AF with regard to security configuration, the AF may send to the UE a K_{AF} update message may carry the security configuration which includes at least one of:
the random number (RAND) from the EAP-AKA′ AV or the 5G HE AV;
an authentication token (AUTN) from the EAP-AKA′ AV or the 5G HE AV; or
the authentication method indicator.

The K_{AF} update message may trigger the UE to update its security configuration.

### Step 14

Once receives the K_{AF} update message from the AF, the UE may update its security configuration, which may include various keys and/or key identifiers.

In one implementation, the UE may first verify the freshness and integrity of the received security configuration, for example, by checking the AUTN received. The AUTN may include a Sequence Number (SQN), and Message Authentication Code (MAC). If the MAC and SQN are successfully verified, the UE derives K_{AUSF} based on the authentication method indicated by the authentication method indicator. If the verification passes, the UE may derive K_{AUSF} based on the authentication method indicated by the authentication method indicator. Specifically, in a case that 5G AKA authentication method is used, the UE may calculate K_{AUSF} based on CK and IK of the UE (with CK and IK retrieved from USIM of the UE). In a case that EAP-AKA′ authentication method is used, the UE may derive CK′ and IK′ from CK and IK, respectively, and then calculate K_{AUSF} based on CK′ and IK′. The UE may then derive K_{AKMA}, and A-KID, for example, in a similar way as in step 8. The UE may further derive K_{AF}, for example, in a similar way as in step 10. The UE may store K_{AKMA}, A-KID and K_{AF} of the UE, for example, in an AKMA security context (or AKMA security association, e.g., an association of the A-KID and the K_{AF}).

### Step 15

Once the UE updates its security configuration, the UE may acknowledge to the AF. The acknowledgement may serve as a trigger for the AF to start a timer associated with the K_{AF}. The duration of the timer may be set to the lifetime of the K_{AF}. An expiration of the timer indicates the expiration of the K_{AF}.

### Step 16

Optionally, after the UE updates its security configuration, such as the K_{AUSF}, the UE may notify the UDM about the successful update, and the UDM may correspondingly store or refresh the AUSF instance associated with the UE.

### Embodiment 2: Key Refresh without NEF

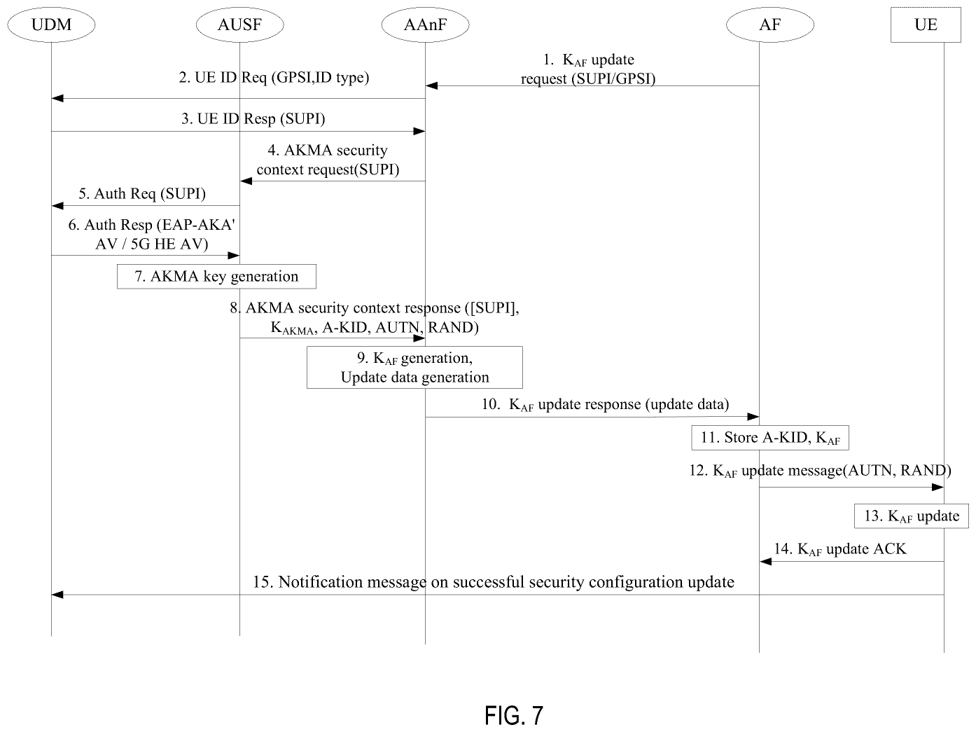

FIG. 7 shows exemplary steps for the AF to refresh security configuration including K_{AF} associated with a UE. The refresh may be further synchronized to the UE

In this embodiment, the AF may have direct access to the core network. Therefore, there is no need to use an NEF as a relay to the core network. Alternatively, the NEF may be co-located with the AAnF. In this case, the existence of the NEF may be transparent to the AF.

With reference to FIG. 7, the exemplary steps are described in details below.

### Step 0

Step 0 is optional and is not shown in FIG. 7. In this step, the UE successfully performs a primary authentication with the core network and the UE is configured with valid security context.

### Step 1

The K_{AF} in the AF is expired or invalid, or the K_{AF} may be lost under a faulty condition. In order to refresh the K_{AF}, the AF may send a K_{AF} update request to the AAnF. The K_{AF} update request may include the identity of the UE, e.g., GPSI, SUPI, or 5G-GUTI of the UE. If SUPI is used in the request, step 2 and step 3 below may be skipped.

In one implementation, an NEF may be co-located with the AAnF.

steps 2-3

Upon receiving the K_{AF} update request message from the AF in step 1, if the identity of the UE in the request message is in the form of GPSI or another format other than SUPI, the AAnF may retrieve the SUPI of the UE from the UDM. In particular, the AAnF may send to the UDM a UE ID request which may include the GPSI and optionally an ID type indicator. The ID type indicator may indicate the ID type for the ID requested. For example, the ID type indicator may indicate the ID in the form of SUPI is requested. The UDM may reply with the SUPI of the UE in a UE ID response message in step 3.

### Step 4

The AAnF may then select an AUSF based on its local policy and send an AKMA Security Context Request to the selected AUSF. The AKMA Security Context Request may include the SUPI of the UE.

In one implementation, the AAnF may be provisioned with AUSF function, or the AAnF and the AUSF may be co-located. In this case, the AAnF may directly interact with the UDM to request the AKMA Security Context from the UDM.

In certain scenario, the AAnF may use the SUPI of the UE to check whether the security context associated with UE is readily available. If yes, the AAnF may retrieve the A-KID from the security context and send the A-KID to the AF. The AF may then re-initiate the K_{AF} update request carrying the A-KID. Embodiments 3-6 covering the scenario in which the A-KID is carried in the K_{AF} update request will be described in later sections.

### Step 5

Upon receiving the AKMA Security Context Request from the AAnF, the AUSF may send an Authentication Request to the UDM. The Authentication Request may be used to request the AKMA security context and may include the SUPI of the UE.

### Step 6

The UDM (or ARPF) may determine the authentication method according to the UE subscription data of the UE. In one implementation, the UDM may retrieve the UE subscription data based on the SUPI of the UE.

If the authentication method is EAP-AKA′, the UDM may reply to the AUSF with an EAP-AKA′ Authentication Vector (AV). The EAP-AKA′ AV may include at least one of:
a random number (RAND), which may be used as a challenge;
an authentication token (AUTN), which may be used for proving the challenge's freshness and authenticity;
an expected response (XRES) to the challenge in an authentication procedure;
a transformation of the cipher key of the UE (transformed key denoted as CK′); or
a transformation of the integrity key of the UE (transformed key denoted as IK′).

The transformation of the cipher key and the integrity key may be based on a predetermined algorithm, such as a KDF.

If the authentication method is 5G AKA, the UDM may reply to the AUSF with a 5G Home Environment Authentication Vector (5G HE AV). The 5G HE AV may include at least one of:
a random number (RAND), which may be used as a challenge;
an authentication token (AUTN), which may be used for proving the challenge's freshness and authenticity;
an expected response (XRES*) to the challenge in an authentication procedure;
an AUSF key (K_{AUSF}) of the UE.

The reply message to the AUSF may further include an authentication method indicator, which indicates what authentication method is chosen for the UE (e.g., 5G AKA, EAP-AKA′, or EAP-TLS).

In one implementation, the reply message to the AUSF may further include a Routing Indicator (RID) of the UE.

### Step 7

Upon receiving the response from the UDM, depending on the authentication method, the AUSF may retrieve the AUSF key (K_{AUSF}) from the response message directly, or may need to derive or generate K_{AUSF}.

If the authentication method indicator indicates that EAP-AKA′ is used as the authentication method, the AUSF may derive K_{AUSF} based on CK′ and IK′.

If the authentication method indicator indicates that 5G AKA is used as the authentication method, the AUSF may retrieve K_{AUSF} from the response message directly. For example, K_{AUSF} may be part of the 5G HE AV.

Next, the AUSF may generate the AKMA Anchor Key (K_{AKMA}) and the A-KID based on K_{AUSF}.

In one implementation, K_{AKMA} may be derived by: K_{AKMA}=KDF (SUPI, K_{AUSF}). KDF refers to an exemplary Key Derivation Function. For example, the KDF may include HMAC-SHA-256 (256-bit Hash-based Message Authentication Code for Secure Hash Algorithm). When using HMAC-SHA-256, the output of the KDF may be a 256-bits key. In one implementation, the output key may further be truncated, for example, to 128 bits. When deriving K_{AKMA} using KDF as described above, SUPI of the UE may be used as a key, and K_{AUSF} may be used as an input.

As described above, A-KID may be used to identify K_{AKMA} of the UE. In one implementation, A-KID may be represented in a Network Access Identifier (NAI) format, i.e. username@realm. The username part may include the RID of the UE and an AKMA Temporary UE Identifier (A-TID) of the UE, and the realm part may include Home Network Identifier of the UE. In one implementation, A-TID may be derived based on K_{AUSF} using a KDF. For example, A-TID=KDF (K_{AUSF}, “AKMA”), i.e., the KDF uses string “AKMA” as the input, and K_{AUSF} as the key. The RID may be received from the UDM as part of the response message in step 6.

In one implementation, K_{AKMA} or A-KID derived in this step may be served as part of the AKMA context of the UE, which is described in detail in steps below.

### Step 8

As a response to the AKMA Security Context Request received from the AAnF in step 4, the AUSF may send a reply message to the AAnF. The reply message may include at least one of:
the random number (RAND) from the EAP-AKA′ AV or the 5G HE AV, depending on the selected authentication method as indicated in step 6;
an authentication token (AUTN) from the EAP-AKA′ AV or the 5G HE AV, depending on the selected authentication method as indicated in step 6;
the authentication method indicator; or
the AKMA context of the UE.

The AKMA context of the UE may include K_{AKMA} of the UE and A-KID identifying K_{AKMA}.

In one implementation, the reply message may further include the SUPI of the UE.

### Step 9

Upon receiving the AKMA context response message from the AUSF, the AAnF may derive the Application Key (K_{AF}) of the UE from K_{AKMA} of the UE. For example, the application key may be determined by K_{AF}=KDF (AF-ID, K_{AKMA}), where AF-ID is the identifier of the AF.

The AAnF may also generate or prepare updated (i.e., currently valid) security data to be sent to the AF in step below. The updated security data may include:
A-KID identifying the K_{AKMA} of the UE;
K_{AF} of the UE corresponding to the AF;
a lifetime of the AKMA security context related configuration information, e.g., a valid time period for the security key such as K_{AF};
the random number (RAND) from the EAP-AKA′ AV or the 5G HE AV, which is received by the AAnF in the step 8;
an authentication token (AUTN) from the EAP-AKA′ AV or the 5G HE AV, which is received by the AAnF in the step 8; or
the authentication method indicator.

### Step 10

Once the updated security data is generated or derived, the AAnF may send the updated security data to the AF, for example, via a K_{AF} update response message, which is a response message to the K_{AF} update request message in step 1.

### Step 11

Based on the response message received in step 11, the AF may store A-KID and K_{AF} of the UE, as well as other security configuration information as seen in the updated security data described in step 9 above.

### Step 12

To ensure UE to be in sync with the AF with regard to security configuration, the AF may send to the UE a K_{AF} update message may carry the security configuration which includes at least one of:
the random number (RAND) from the EAP-AKA′ AV or the 5G HE AV;
an authentication token (AUTN) from the EAP-AKA′ AV or the 5G HE AV; or
the authentication method indicator.

The K_{AF} update message may trigger the UE to update its security configuration.

### Step 13

Once receives the K_{AF} update message from the AF, the UE may update its security configuration, which may include various keys and/or key identifiers.

In one implementation, the UE may first verify the freshness and integrity of the received security configuration, for example, by checking the AUTN received. The AUTN may include a Sequence Number (SQN), and Message Authentication Code (MAC). If the MAC and SQN are successfully verified, the UE derives K_{AUSF} based on the authentication method indicated by the authentication method indicator. If the verification passes, the UE may derive K_{AUSF} based on the authentication method indicated by the authentication method indicator. Specifically, in a case that 5G AKA authentication method is used, the UE may calculate K_{AUSF} based on CK and IK of the UE (with CK and IK retrieved from USIM of the UE). In a case that EAP-AKA′ authentication method is used, the UE may derive CK′ and IK′ from CK and IK, respectively, and then calculate K_{AUSF} based on CK′ and IK′. The UE may then derive K_{AKMA}, and A-KID, for example, in a similar way as in step 7. The UE may further derive K_{AF}, for example, in a similar way as in step 9. The UE may store K_{AKMA}, A-KID and K_{AF} of the UE, for example, in an AKMA security context (or AKMA security association, e.g., an association of the A-KID and the K_{AF}).

### Step 14

Once the UE updates its security configuration, the UE may acknowledge to the AF. The acknowledgement may serve as a trigger for the AF to start a timer associated with the K_{AF}. The duration of the timer may be set to the lifetime of the K_{AF}. An expiration of the timer indicates the expiration of the K_{AF}.

### Step 15

Optionally, after the UE updates its security configuration, such as the K_{AUSF}, the UE may notify the UDM about the successful update, and the UDM may correspondingly store or refresh the AUSF instance associated with the UE.

### Embodiment 3: Key Refresh Using NEF-Conditional AKMA Security Context Request

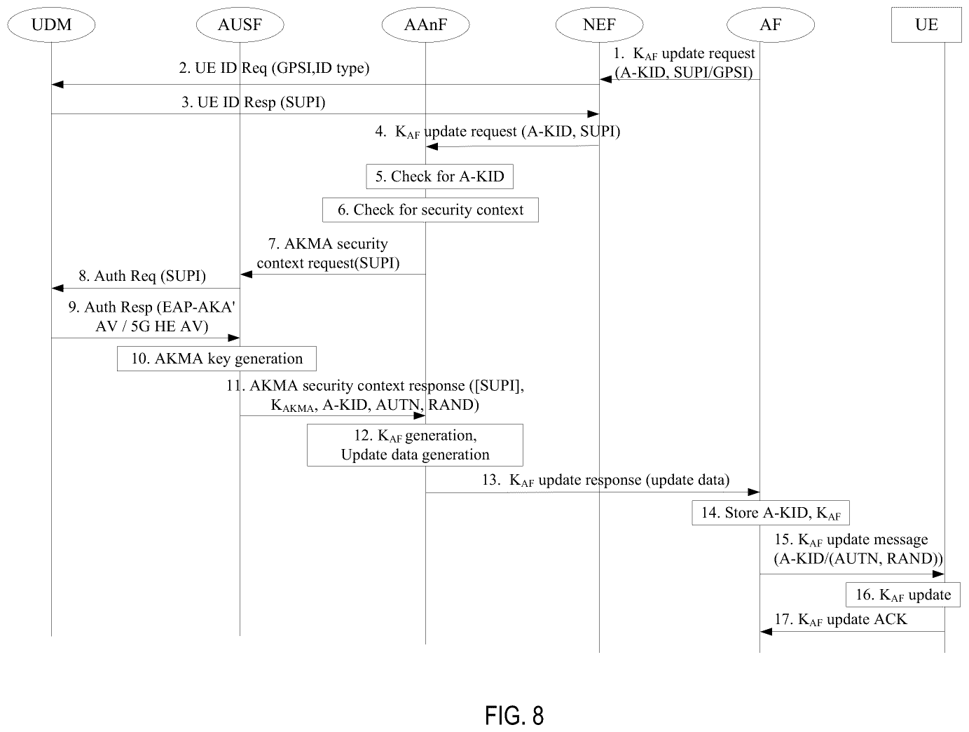

FIG. 8 shows exemplary steps for the AF to refresh security configuration including K_{AF} associated with a UE. The refresh is further synchronized to the UE.

In this embodiment, the AF does not have direct access to the AAnF, for example, if the AF is allocated outside of the core network (e.g., AUSF, UDM, etc.). Therefore, the NEF is utilized as a relay to the core network.

In this embodiment, additional factors are considered by the AAnF. To at least save signaling overhead and reduce network element interactions, the AAnF may check if a valid security context associated with the UE is locally available. If the security context is available, then the AAnF may not need to interact with core network elements such as AUSF and/or UDM to solicit UE security context. This check performed by the AAnf may further help reducing signaling overhead in later steps, as less data may need to be transmitted via signaling.

With reference to FIG. 8, the exemplary steps are described in details below.

### Step 0

Step 0 is optional and is not shown in FIG. 8. In this step, the UE successfully performs a primary authentication with the core network and the UE is configured with valid security context.

### Step 1

The K_{AF} in the AF is expired or invalid, or the K_{AF} may be lost under a faulty condition. In order to refresh the K_{AF}, the AF may send a K_{AF} update request to the Network Exposure Function (NEF). The K_{AF} update request may include the A-KID of the UE. The K_{AF} update request may further include the identity of the UE, e.g., Generic Public Subscription Identifier (GPSI), SUPI, or 5G-GUTI of the UE. In one implementation, the GPSI may be used when the AF is located outside the operator's network. If SUPI is used in the request, step 2 and step 3 below may be skipped.

### Steps 2-3

Upon receiving the K_{AF} update request message from the AF in step 1, if the identity of the UE in the request message is in the form of GPSI or another format other than SUPI, the NEF may retrieve the SUPI of the UE from the UDM. In particular, the NEF may send to the UDM a UE ID request which may include the GPSI and optionally an ID type indicator. The ID type indicator may indicate the ID type for the ID requested. For example, the ID type indicator may indicate the ID in the form of SUPI is requested. The UDM may reply with the SUPI of the UE in a UE ID response message in step 3.

### Step 4

The NEF sends a K_{AF} update request to the AAnF. The K_{AF} update request may include the A-KID and the SUPI of the UE.

### Step 5

Upon receiving the K_{AF} update request message carrying the A-KID, the AAnF may check if a same A-KID is already configured (or provisioned, stored) in the AAnF. If a same A-KID is configured in the AAnF, then step 6 below is skipped.

### Step 6

Based on the SUPI carried in K_{AF} update request message, the AAnF may further check if a valid security context (e.g., AKMA security context) corresponding to the SUPI is configured (or provisioned, stored) in the AAnF. For example, the AAnF may check if an K_{AKMA} corresponding to the SUPI exists.

In case that the security context corresponding to the SUPI is configured, for example, if step 0 is executed before step 1 and the UE successfully performs a primary authentication, then the AAnF does not need to request for UE specific security context from the core network (e.g., AUSF, UDM), and steps 7-11 below may be skipped.

### Step 7

The AAnF may then select an AUSF based on its local policy and send an AKMA Security Context Request to the selected AUSF. The AKMA Security Context Request may include the SUPI of the UE.

In one implementation, the AAnF may be provisioned with AUSF function, or the AAnF and the AUSF may be co-located. In this case, the AAnF may directly interact with the UDM to request the AKMA Security Context from the UDM.

### Step 8

Upon receiving the AKMA Security Context Request from the AAnF, the AUSF may send an Authentication Request to the UDM. The Authentication Request may be used to request the AKMA security context and may include the SUPI of the UE.

### Step 9

The UDM (or ARPF) may determine the authentication method according to the UE subscription data of the UE. In one implementation, the UDM may retrieve the UE subscription data based on the SUPI of the UE.

If the authentication method is EAP-AKA′, the UDM may reply to the AUSF with an EAP-AKA′ Authentication Vector (AV). The EAP-AKA′ AV may include at least one of:
a random number (RAND), which may be used as a challenge;
an authentication token (AUTN), which may be used for proving the challenge's freshness and authenticity;
an expected response (XRES) to the challenge in an authentication procedure;
a transformation of the cipher key of the UE (transformed key denoted as CK′); or
a transformation of the integrity key of the UE (transformed key denoted as IK′).

The transformation of the cipher key and the integrity key may be based on a predetermined algorithm, such as a KDF.

If the authentication method is 5G AKA, the UDM may reply to the AUSF with a 5G Home Environment Authentication Vector (5G HE AV). The 5G HE AV may include at least one of:
a random number (RAND), which may be used as a challenge;
an authentication token (AUTN), which may be used for proving the challenge's freshness and authenticity;
an expected response (XRES*) to the challenge in an authentication procedure;
an AUSF key (K_{AUSF}) of the UE.

The reply message to the AUSF may further include an authentication method indicator, which indicates what authentication method is chosen for the UE (e.g., 5G AKA, EAP-AKA′, or EAP-TLS).

In one implementation, the reply message to the AUSF may further include a Routing Indicator (RID) of the UE.

### Step 10

Upon receiving the response from the UDM, depending on the authentication method, the AUSF may retrieve the AUSF key (K_{AUSF}) from the response message directly, or may need to derive or generate K_{AUSF}.

If the authentication method indicator indicates that EAP-AKA′ is used as the authentication method, the AUSF may derive K_{AUSF} based on CK′ and IK′.

If the authentication method indicator indicates that 5G AKA is used as the authentication method, the AUSF may retrieve K_{AUSF} from the response message directly. For example, K_{AUSF} may be part of the 5G HE AV.

Next, the AUSF may generate the AKMA Anchor Key (K_{AKMA}) and the A-KID based on K_{AUSF}.

In one implementation, K_{AKMA} may be derived by: K_{AKMA}=KDF (SUPI, K_{AUSF}). KDF refers to an exemplary Key Derivation Function. For example, the KDF may include HMAC-SHA-256 (256-bit Hash-based Message Authentication Code for Secure Hash Algorithm). When using HMAC-SHA-256, the output of the KDF may be a 256-bits key. In one implementation, the output key may further be truncated, for example, to 128 bits. When deriving K_{AKMA} using KDF as described above, SUPI of the UE may be used as a key, and K_{AUSF} may be used as an input.

As described above, A-KID may be used to identify K_{AKMA} of the UE. In one implementation, A-KID may be represented in a Network Access Identifier (NAI) format, i.e. username@realm. The username part may include the RID of the UE and an AKMA Temporary UE Identifier (A-TID) of the UE, and the realm part may include Home Network Identifier of the UE. In one implementation, A-TID may be derived based on K_{AUSF} using a KDF. For example, A-TID=KDF (K_{AUSF}, “AKMA”), i.e., the KDF uses string “AKMA” as the input, and K_{AUSF} as the key. The RID may be received from the UDM as part of the response message in step 9.

In one implementation, K_{AKMA} or A-KID derived in this step may be served as part of the AKMA context of the UE, which is described in detail in steps below.

### Step 11

As a response to the AKMA Security Context Request received from the AAnF in step 7, the AUSF may send a reply message to the AAnF. The reply message may include at least one of:
the random number (RAND) from the EAP-AKA′ AV or the 5G HE AV, depending on the selected authentication method as indicated in step 9;
an authentication token (AUTN) from the EAP-AKA′ AV or the 5G HE AV, depending on the selected authentication method as indicated in step 9;
the authentication method indicator; or
the AKMA context of the UE.

The AKMA context of the UE may include K_{AKMA} of the UE and A-KID identifying K_{AKMA}.

In one implementation, the reply message may further include the SUPI of the UE.

### Step 12

Upon receiving the AKMA context response message from the AUSF, the AAnF may derive the Application Key (K_{AF}) of the UE from K_{AKMA} of the UE. For example, the application key may be determined by K_{AF}=KDF (AF-ID, K_{AKMA}), where AF-ID is the identifier of the AF.

The AAnF may also generate or prepare updated (i.e., currently valid) security data to be sent to the AF in step below. The updated security data may have different content in different cases.

### Case A

In case A, the security context for the UE exists or is configured in the AAnF in step 6. The updated security data may include:
A-KID identifying the K_{AKMA} of the UE.
K_{AF} of the UE corresponding to the AF;
a lifetime of the AKMA security context related configuration information, e.g., a valid time period for the security key such as K_{AF}.

### Case B

In case B, a same A-KID is configured in the AAnF as described in step 5, or the security context of the UE does not exist or is not configured in the AAnF as described in step 6. The updated security data may include:
A-KID identifying the K_{AKMA} of the UE;
K_{AF} of the UE corresponding to the AF;
a lifetime of the AKMA security context related configuration information, e.g., a valid time period for the security key such as K_{AF};
the random number (RAND) from the EAP-AKA′ AV or the 5G HE AV, which is received by the AAnF in the step 11;
an authentication token (AUTN) from the EAP-AKA′ AV or the 5G HE AV, which is received by the AAnF in the step 11; or
the authentication method indicator.

### Step 13

Once the updated security data is generated or derived, the AAnF may send the updated security data to the AF, for example, via a K_{AF} update response message, which is a response message to the K_{AF} update request message in step 4 (or essentially step 1).

### Step 14

Based on the response message received in step 13, the AF may store A-KID and K_{AF} of the UE, as well as other security configuration information as seen in the updated security data described above.

### Step 15

To ensure UE to be in sync with the AF with regard to security configuration, the AF may send to the UE a K_{AF} update message may carry the security configuration. Based on different cases as described above, the security configuration may include different content:

### Case A

A-KID identifying the K_{AKMA} of the UE.

### Case B

the random number (RAND) from the EAP-AKA′ AV or the 5G HE AV;
an authentication token (AUTN) from the EAP-AKA′ AV or the 5G HE AV; or
the authentication method indicator.

The K_{AF} update message may trigger the UE to update its security configuration.

### Step 16

Once receives the K_{AF} update message from the AF, the UE may update its security configuration, which may include various keys and/or key identifiers.

### Case A

In this case, the UE may have performed a successful primary authentication, for example, in step 0. The UE may derive its K_{AF} based on the A-KID received from the K_{AF} update message, along with security context from the primary authentication.

### Case B

In this case, the UE may first verify the freshness and integrity of the received security configuration, for example, by checking the AUTN received. The AUTN may include a Sequence Number (SQN), and Message Authentication Code (MAC). If the MAC and SQN are successfully verified, the UE derives K_{AUSF} based on the authentication method indicated by the authentication method indicator. If the verification passes, the UE may derive K_{AUSF} based on the authentication method indicated by the authentication method indicator. Specifically, in a case that 5G AKA authentication method is used, the UE may calculate K_{AUSF} based on CK and IK of the UE (with CK and IK retrieved from USIM of the UE). In a case that EAP-AKA′ authentication method is used, the UE may derive CK′ and IK′ from CK and IK, respectively, and then calculate K_{AUSF} based on CK′ and IK′. The UE may then derive K_{AKMA}, and A-KID, for example, in a similar way as in step 10. The UE may further derive K_{AF}, for example, in a similar way as in step 12. The UE may store K_{AKMA}, A-KID and K_{AF} of the UE, for example, in an AKMA security context (or AKMA security association, e.g., an association of the A-KID and the K_{AF}).

### Step 17

Once the UE updates its security configuration, the UE may acknowledge to the AF. The acknowledgement may serve as a trigger for the AF to start a timer associated with the K_{AF}. The duration of the timer may be set to the lifetime of the K_{AF}. An expiration of the timer indicates the expiration of the K_{AF}.

Optionally, after the UE updates its security configuration, such as the K_{AUSF}, the UE may notify the UDM about the successful update, and the UDM may correspondingly store or refresh the AUSF instance associated with the UE.

### Embodiment 4: Key Refresh Using NEF-Conditional AKMA Security Context Request

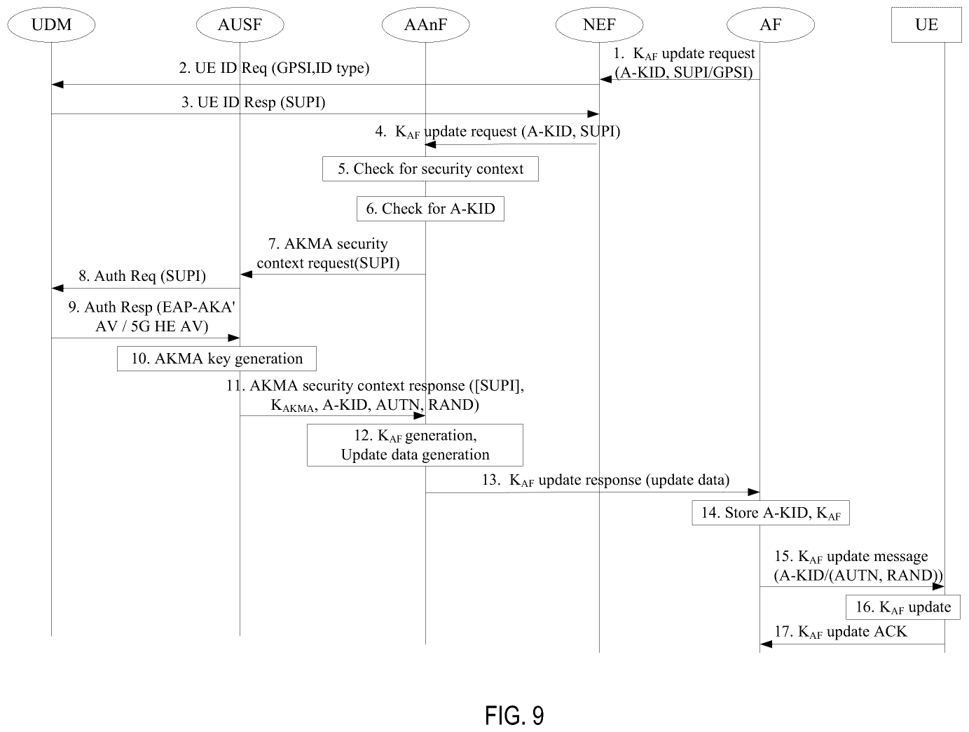

FIG. 9 shows exemplary steps for the AF to refresh security configuration including K_{AF} associated with a UE. The refresh may be further synchronized to the UE.

In this embodiment, the AF does not have direct access to the AAnF, for example, if the AF is allocated outside of the core network (e.g., AUSF, UDM, etc.). Therefore, in an exemplary implementation, the NEF is utilized as a relay to the core network.

In this embodiment, additional factors are considered by the AAnF. To at least save signaling overhead and reduce network element interactions, the AAnF may check if a valid security context associated with the UE is locally available. If the security context is available, then the AAnF may not need to interact with core network elements such as AUSF and/or UDM to solicit UE security context. This check performed by the AAnf may further help reducing signaling overhead in later steps, as less data may need to be transmitted via signaling.

With reference to FIG. 9, the exemplary steps are described in details below.

### Step 0

Step 0 is optional and is not shown in FIG. 9. In this step, the UE successfully performs a primary authentication with the core network and the UE is configured with valid security context.

### Step 1

The K_{AF} in the AF is expired or invalid, or the K_{AF} may be lost under a faulty condition. In order to refresh the K_{AF}, the AF may send a K_{AF} update request to the Network Exposure Function (NEF). The K_{AF} update request may include the A-KID of the UE. The K_{AF} update request may further include the identity of the UE, e.g., Generic Public Subscription Identifier (GPSI), SUPI, or 5G-GUTI of the UE. In one implementation, the GPSI may be used when the AF is located outside the operator's network. If SUPI is used in the request, step 2 and step 3 below may be skipped.

### Steps 2-3

Upon receiving the K_{AF} update request message from the AF in step 1, if the identity of the UE in the request message is in the form of GPSI or another format other than SUPI, the NEF may retrieve the SUPI of the UE from the UDM. In particular, the NEF may send to the UDM a UE ID request which may include the GPSI and optionally an ID type indicator. The ID type indicator may indicate the ID type for the ID requested. For example, the ID type indicator may indicate the ID in the form of SUPI is requested. The UDM may reply with the SUPI of the UE in a UE ID response message in step 3.

### Step 4

The NEF sends a K_{AF} update request to the AAnF. The K_{AF} update request may include the A-KID and the SUPI of the UE.

### Step 5

Based on the SUPI carried in K_{AF} update request message, the AAnF may check if there is UE security context (e.g., AKMA security context) configured (or provisioned, stored) in the AAnF corresponding to the SUPI. For example, the AAnF may check if an K_{AKMA} corresponding to the SUPI exists.

In case that the security context corresponding to the SUPI is not configured, step 6 may be skipped. Otherwise, step 6 below is performed.

### Step 6

The AAnF may compare the A-KID received from the K_{AF} update request message with the A-KID in the UE security context which is configured (or provisioned, stored) in the AAnF. If the two A-KIDs are different, then steps 7-11 below may be skipped. This scenario may happen when the UE just performs a successful primary authentication in step 0. If the two A-KIDs are the same, then step 7 is performed.

### Step 7

The AAnF may then select an AUSF based on its local policy and send an AKMA Security Context Request to the selected AUSF. The AKMA Security Context Request may include the SUPI of the UE.

In one implementation, the AAnF may be provisioned with AUSF function, or the AAnF and the AUSF may be co-located. In this case, the AAnF may directly interact with the UDM to request the AKMA Security Context from the UDM.

### Step 8

Upon receiving the AKMA Security Context Request from the AAnF, the AUSF may send an Authentication Request to the UDM. The Authentication Request may be used to request the AKMA security context and may include the SUPI of the UE.

### Step 9

The UDM (or ARPF) may determine the authentication method according to the UE subscription data of the UE. In one implementation, the UDM may retrieve the UE subscription data based on the SUPI of the UE.

If the authentication method is EAP-AKA′, the UDM may reply to the AUSF with an EAP-AKA′ Authentication Vector (AV). The EAP-AKA′ AV may include at least one of:
a random number (RAND), which may be used as a challenge;
an authentication token (AUTN), which may be used for proving the challenge's freshness and authenticity;
an expected response (XRES) to the challenge in an authentication procedure;
a transformation of the cipher key of the UE (transformed key denoted as CK′); or
a transformation of the integrity key of the UE (transformed key denoted as IK′).

The transformation of the cipher key and the integrity key may be based on a predetermined algorithm, such as a KDF.

If the authentication method is 5G AKA, the UDM may reply to the AUSF with a 5G Home Environment Authentication Vector (5G HE AV). The 5G HE AV may include at least one of:
a random number (RAND), which may be used as a challenge;
an authentication token (AUTN), which may be used for proving the challenge's freshness and authenticity;
an expected response (XRES*) to the challenge in an authentication procedure;
an AUSF key (K_{AUSF}) of the UE.

The reply message to the AUSF may further include an authentication method indicator, which indicates what authentication method is chosen for the UE (e.g., 5G AKA, EAP-AKA′, or EAP-TLS).

In one implementation, the reply message to the AUSF may further include a Routing Indicator (RID) of the UE.

### Step 10

Upon receiving the response from the UDM, depending on the authentication method, the AUSF may retrieve the AUSF key (K_{AUSF}) from the response message directly, or may need to derive or generate K_{AUSF}.

If the authentication method indicator indicates that EAP-AKA′ is used as the authentication method, the AUSF may derive K_{AUSF} based on CK′ and IK′.

If the authentication method indicator indicates that 5G AKA is used as the authentication method, the AUSF may retrieve K_{AUSF} from the response message directly. For example, K_{AUSF} may be part of the 5G HE AV.

Next, the AUSF may generate the AKMA Anchor Key (K_{AKMA}) and the A-KID based on K_{AUSF}.

In one implementation, K_{AKMA} may be derived by: K_{AKMA}=KDF (SUPI, K_{AUSF}). KDF refers to an exemplary Key Derivation Function. For example, the KDF may include HMAC-SHA-256 (256-bit Hash-based Message Authentication Code for Secure Hash Algorithm). When using HMAC-SHA-256, the output of the KDF may be a 256-bits key. In one implementation, the output key may further be truncated, for example, to 128 bits. When deriving K_{AKMA} using KDF as described above, SUPI of the UE may be used as a key, and K_{AUSF} may be used as an input.

As described above, A-KID may be used to identify K_{AKMA} of the UE. In one implementation, A-KID may be represented in a Network Access Identifier (NAI) format, i.e. username@realm. The username part may include the RID of the UE and an AKMA Temporary UE Identifier (A-TID) of the UE, and the realm part may include Home Network Identifier of the UE. In one implementation, A-TID may be derived based on K_{AUSF} using a KDF. For example, A-TID=KDF (K_{AUSF}, “AKMA”), i.e., the KDF uses string “AKMA” as the input, and K_{AUSF} as the key. The RID may be received from the UDM as part of the response message in step 9.

In one implementation, K_{AKMA} or A-KID derived in this step may be served as part of the AKMA security context of the UE, which is described in detail in steps below.

### Step 11

As a response to the AKMA Security Context Request received from the AAnF in step 5, the AUSF may send a reply message to the AAnF. The reply message may include at least one of:
the random number (RAND) from the EAP-AKA′ AV or the 5G HE AV, depending on the selected authentication method;
an authentication token (AUTN) from the EAP-AKA′ AV or the 5G HE AV, depending on the selected authentication method;
the authentication method indicator; or
the AKMA context of the UE.

The AKMA context of the UE may include K_{AKMA} of the UE and A-KID identifying K_{AKMA}.

In one implementation, the reply message may further include the SUPI of the UE.

### Step 12

Upon receiving the AKMA context response message from the AUSF, the AAnF may derive the Application Key (K_{AF}) of the UE from K_{AKMA} of the UE. For example, the application key may be determined by K_{AF}=KDF (AF-ID, K_{AKMA}), where AF-ID is the identifier of the AF.

The AAnF may also generate or prepare updated (i.e., currently valid) security data to be sent to the AF in step below. The updated security data may have different content in different cases.

### Case A

In case A, the two A-KIDs as described in step 6 are different. The updated security data may include:
A-KID identifying the K_{AKMA} of the UE.
K_{AF} of the UE corresponding to the AF;
a lifetime of the AKMA security context related configuration information, e.g., a valid time period for the security key such as K_{AF}.

### Case B

In case B, the UE security context corresponding to the SUPI is not configured in the AAnF in step 5, or the two A-KIDs as described in step 6 are the same. The updated security data may include:
A-KID identifying the K_{AKMA} of the UE;
K_{AF} of the UE corresponding to the AF;
a lifetime of the AKMA security context related configuration information, e.g., a valid time period for the security key such as K_{AF};
the random number (RAND) from the EAP-AKA′ AV or the 5G HE AV, which is received by the AAnF in the step 11;
an authentication token (AUTN) from the EAP-AKA′ AV or the 5G HE AV, which is received by the AAnF in the step 11; or
the authentication method indicator.

### Step 13

Once the updated security data is generated or derived, the AAnF may send the updated security data to the AF, for example, via a K_{AF} update response message, which is a response message to the K_{AF} update request message in step 4 (or essentially step 1).

### Step 14

Based on the response message received in step 13, the AF may store A-KID and K_{AF} of the UE, as well as other security configuration information as seen in the updated security data described above.

### Step 15

To ensure UE to be in sync with the AF with regard to security configuration, the AF may send to the UE a K_{AF} update message may carry the security configuration. Based on different cases as described above, the security configuration may include different content:

### Case A

A-KID identifying the K_{AKMA} of the UE.

### Case B

the random number (RAND) from the EAP-AKA′ AV or the 5G HE AV;
an authentication token (AUTN) from the EAP-AKA′ AV or the 5G HE AV; or
the authentication method indicator.

The K_{AF} update message may trigger the UE to update its security configuration.

### Step 16

Once receives the K_{AF} update message from the AF, the UE may update its security configuration, which may include various keys and/or key identifiers.

### Case A

In this case, the UE may have performed a successful primary authentication, for example, in step 0. The UE may derive its K_{AF} based on the A-KID received from the K_{AF} update message, along with security context from the primary authentication.

### Case B

In this case, the UE may first verify the freshness and integrity of the received security configuration, for example, by checking the AUTN received. The AUTN may include a Sequence Number (SQN), and Message Authentication Code (MAC). If the MAC and SQN are successfully verified, the UE derives K_{AUSF} based on the authentication method indicated by the authentication method indicator. If the verification passes, the UE may derive K_{AUSF} based on the authentication method indicated by the authentication method indicator. Specifically, in a case that 5G AKA authentication method is used, the UE may calculate K_{AUSF} based on CK and IK of the UE (with CK and IK retrieved from USIM of the UE). In a case that EAP-AKA′ authentication method is used, the UE may derive CK′ and IK′ from CK and IK, respectively, and then calculate K_{AUSF} based on CK′ and IK′. The UE may then derive K_{AKMA}, and A-KID, for example, in a similar way as in step 10. The UE may further derive K_{AF}, for example, in a similar way as in step 12. The UE may store K_{AKMA}, A-KID and K_{AF} of the UE, for example, in an AKMA security context (or AKMA security association, e.g., an association of the A-KID and the K_{AF}).

### Step 17

Once the UE updates its security configuration, the UE may acknowledge to the AF. The acknowledgement may serve as a trigger for the AF to start a timer associated with the K_{AF}. The duration of the timer may be set to the lifetime of the K_{AF}. An expiration of the timer indicates the expiration of the K_{AF}.

Optionally, after the UE updates its security configuration, such as the K_{AUSF}, the UE may notify the UDM about the successful update, and the UDM may correspondingly store or refresh the AUSF instance associated with the UE.

### Embodiment 5: Key Refresh without NEF-Conditional AKMA Security Context Request

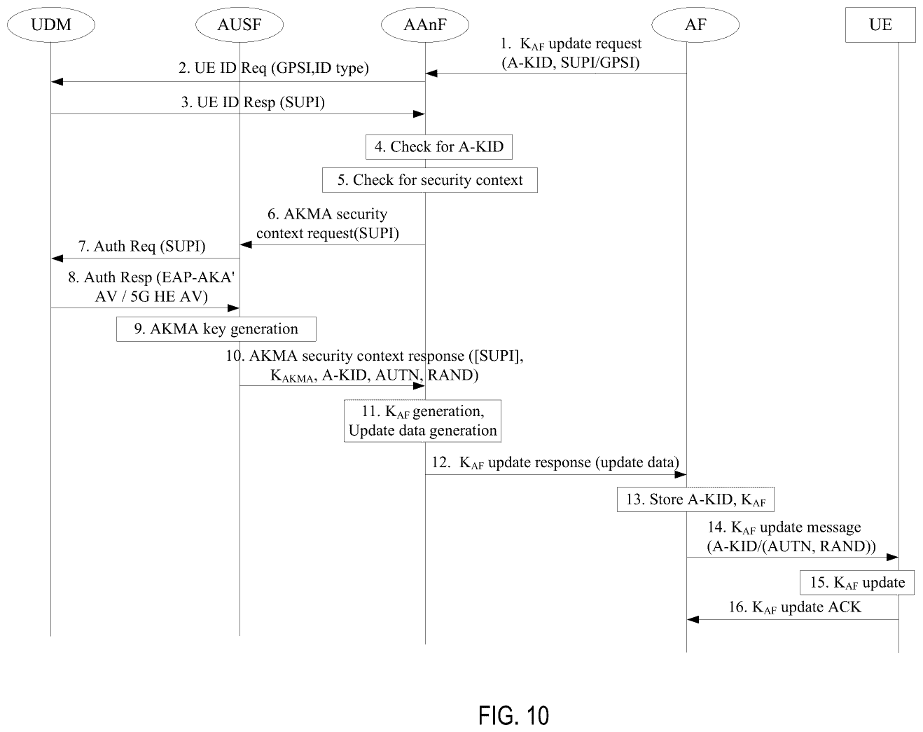

FIG. 10 shows exemplary steps for the AF to refresh security configuration including K_{AF} associated with a UE. The refresh is further synchronized to the UE.

In this embodiment, the AF may have direct access to the core network. Therefore, there is no need to use an NEF as a relay to the core network. Alternatively, the NEF may be co-located with the AAnF. In this case, the existence of the NEF may be transparent to the AF.

In this embodiment, additional factors are considered by the AAnF. To at least save signaling overhead and reduce network element interactions, the AAnF may check if a valid security context associated with the UE is locally available. If the security context is available, then the AAnF may not need to interact with core network elements such as AUSF and/or UDM to solicit UE security context. This check performed by the AAnf may further help reducing signaling overhead in later steps, as less data may need to be transmitted via signaling.

With reference to FIG. 10, the exemplary steps are described in details below.

### Step 0

Step 0 is optional and is not shown in FIG. 10. In this step, the UE successfully performs a primary authentication with the core network and the UE is configured with valid security context.

### Step 1

The K_{AF} in the AF is expired or invalid, or the K_{AF} may be lost under a faulty condition. In order to refresh the K_{AF}, the AF may send a K_{AF} update request to the AAnF. The K_{AF} update request may include the A-KID of the UE. The K_{AF} update request may further include the identity of the UE, e.g., GPSI, SUPI, or 5G-GUTI of the UE. If SUPI is used in the request, step 2 and step 3 below may be skipped

### Steps 2-3

Upon receiving the K_{AF} update request message from the AF in step 1, if the identity of the UE in the request message is in the form of GPSI or another format other than SUPI, the AAnF may retrieve the SUPI of the UE from the UDM. In particular, the AAnF may send to the UDM a UE ID request which may include the GPSI and optionally an ID type indicator. The ID type indicator may indicate the ID type for the ID requested. For example, the ID type indicator may indicate the ID in the form of SUPI is requested. The UDM may reply with the SUPI of the UE in a UE ID response message in step 3.

### Step 4

Upon receiving the K_{AF} update request message carrying the A-KID, the AAnF may check if a same A-KID is already configured (or provisioned, stored) in the AAnF. If a same A-KID is configured in the AAnF, then step 5 below is skipped.

### Step 5

Based on the SUPI carried in K_{AF} update request message, the AAnF may further check if a valid security context (e.g., AKMA security context) corresponding to the SUPI is configured (or provisioned, stored) in the AAnF. For example, the AAnF may check if an K_{AKMA} corresponding to the SUPI exists

In case that the UE security context is configured, for example, if step 0 is executed before step 1 and the UE successfully performs a primary authentication, then the AAnF does not need to request for UE specific security context from the core network (e.g., AUSF, UDM), and steps 6-10 below may be skipped.

### Step 6

The AAnF may then select an AUSF based on its local policy and send an AKMA Security Context Request to the selected AUSF. The AKMA Security Context Request may include the SUPI of the UE.

In one implementation, the AAnF may be provisioned with AUSF function, or the AAnF and the AUSF may be co-located. In this case, the AAnF may directly interact with the UDM to request the AKMA Security Context from the UDM.

### Step 7

Upon receiving the AKMA Security Context Request from the AAnF, the AUSF may send an Authentication Request to the UDM. The Authentication Request may be used to request the AKMA security context and may include the SUPI of the UE.

### Step 8

The UDM (or ARPF) may determine the authentication method according to the UE subscription data of the UE. In one implementation, the UDM may retrieve the UE subscription data based on the SUPI of the UE.

If the authentication method is EAP-AKA′, the UDM may reply to the AUSF with an EAP-AKA′ Authentication Vector (AV). The EAP-AKA′ AV may include at least one of:
a random number (RAND), which may be used as a challenge;
an authentication token (AUTN), which may be used for proving the challenge's freshness and authenticity;
an expected response (XRES) to the challenge in an authentication procedure;
a transformation of the cipher key of the UE (transformed key denoted as CK′); or
a transformation of the integrity key of the UE (transformed key denoted as IK′).

The transformation of the cipher key and the integrity key may be based on a predetermined algorithm, such as a KDF.

If the authentication method is 5G AKA, the UDM may reply to the AUSF with a 5G Home Environment Authentication Vector (5G HE AV). The 5G HE AV may include at least one of:
a random number (RAND), which may be used as a challenge;
an authentication token (AUTN), which may be used for proving the challenge's freshness and authenticity;
an expected response (XRES*) to the challenge in an authentication procedure;
an AUSF key (K_{AUSF}) of the UE.

The reply message to the AUSF may further include an authentication method indicator, which indicates what authentication method is chosen for the UE (e.g., 5G AKA, EAP-AKA′, or EAP-TLS).

In one implementation, the reply message to the AUSF may further include a Routing Indicator (RID) of the UE.

### Step 9

Upon receiving the response from the UDM, depending on the authentication method, the AUSF may retrieve the AUSF key (K_{AUSF}) from the response message directly, or may need to derive or generate K_{AUSF}.

If the authentication method indicator indicates that EAP-AKA′ is used as the authentication method, the AUSF may derive K_{AUSF} based on CK′ and IK′.

If the authentication method indicator indicates that 5G AKA is used as the authentication method, the AUSF may retrieve K_{AUSF} from the response message directly. For example, K_{AUSF} may be part of the 5G HE AV.

Next, the AUSF may generate the AKMA Anchor Key (K_{AKMA}) and the A-KID based on K_{AUSF}.

In one implementation, K_{AKMA} may be derived by: K_{AKMA}=KDF (SUPI, K_{AUSF}). KDF refers to an exemplary Key Derivation Function. For example, the KDF may include HMAC-SHA-256 (256-bit Hash-based Message Authentication Code for Secure Hash Algorithm). When using HMAC-SHA-256, the output of the KDF may be a 256-bits key. In one implementation, the output key may further be truncated, for example, to 128 bits. When deriving K_{AKMA} using KDF as described above, SUPI of the UE may be used as a key, and K_{AUSF} may be used as an input.

As described above, A-KID may be used to identify K_{AKMA} of the UE. In one implementation, A-KID may be represented in a Network Access Identifier (NAI) format, i.e. username@realm. The username part may include the RID of the UE and an AKMA Temporary UE Identifier (A-TID) of the UE, and the realm part may include Home Network Identifier of the UE. In one implementation, A-TID may be derived based on K_{AUSF} using a KDF. For example, A-TID=KDF (K_{AUSF}, “AKMA”), i.e., the KDF uses string “AKMA” as the input, and K_{AUSF} as the key. The RID may be received from the UDM as part of the response message in step 8.

In one implementation, K_{AKMA} or A-KID derived in this step may be served as part of the AKMA context of the UE, which is described in detail in steps below.

### Step 10

As a response to the AKMA Security Context Request received from the AAnF in step 5, the AUSF may send a reply message to the AAnF. The reply message may include at least one of:
the random number (RAND) from the EAP-AKA′ AV or the 5G HE AV, depending on the selected authentication method;
an authentication token (AUTN) from the EAP-AKA′ AV or the 5G HE AV, depending on the selected authentication method;
the authentication method indicator; or
the AKMA context of the UE.

The AKMA context of the UE may include K_{AKMA} of the UE and A-KID identifying K_{AKMA}.

In one implementation, the reply message may further include the SUPI of the UE.

### Step 11

Upon receiving the AKMA context response message from the AUSF, the AAnF may derive the Application Key (K_{AF}) of the UE from K_{AKMA} of the UE. For example, the application key may be determined by K_{AF}=KDF (AF-ID, K_{AKMA}), where AF-ID is the identifier of the AF.

The AAnF may also generate or prepare updated (i.e., currently valid) security data to be sent to the AF in step below. The updated security data may have different content in different cases.

### Case A

In case A, the security context exists or is configured in the AAnF in step 5. The updated security data may include:
A-KID identifying the K_{AKMA} of the UE.
K_{AF} of the UE corresponding to the AF;
a lifetime of the AKMA security context related configuration information, e.g., a valid time period for the security key such as K_{AF}.

### Case B

In case B, a same A-KID is configured in the AAnF as described in step 4, or the UE security context does not exist or is not configured in the AAnF as described in step 5.

The updated security data may include:
A-KID identifying the K_{AKMA} of the UE;
K_{AF} of the UE corresponding to the AF;
a lifetime of the AKMA security context related configuration information, e.g., a valid time period for the security key such as K_{AF};
the random number (RAND) from the EAP-AKA′ AV or the 5G HE AV, which is received by the AAnF in the step 10;
an authentication token (AUTN) from the EAP-AKA′ AV or the 5G HE AV, which is received by the AAnF in the step 10; or
the authentication method indicator.

### Step 12

Once the updated security data is generated or derived, the AAnF may send the updated security data to the AF, for example, via a K_{AF} update response message, which is a response message to the K_{AF} update request message in step 1.

### Step 13

Based on the response message received in step 12, the AF may store A-KID and K_{AF} of the UE, as well as other security configuration information as seen in the updated security data described above.

### Step 14

To ensure UE to be in sync with the AF with regard to security configuration, the AF may send to the UE a K_{AF} update message may carry the security configuration. Based on different cases as described above, the security configuration may include different content:

### Case A

A-KID identifying the K_{AKMA} of the UE.

### Case B

the random number (RAND) from the EAP-AKA′ AV or the 5G HE AV;
an authentication token (AUTN) from the EAP-AKA′ AV or the 5G HE AV; or
the authentication method indicator.

The K_{AF} update message may trigger the UE to update its security configuration.

### Step 15

Once receives the K_{AF} update message from the AF, the UE may update its security configuration, which may include various keys and/or key identifiers.

### Case A

In this case, the UE may have performed a successful primary authentication, for example, in step 0. The UE may derive its K_{AF} based on the A-KID received from the K_{AF} update message, along with security context from the primary authentication.

### Case B

In this case, the UE may first verify the freshness and integrity of the received security configuration, for example, by checking the AUTN received. The AUTN may include a Sequence Number (SQN), and Message Authentication Code (MAC). If the MAC and SQN are successfully verified, the UE derives K_{AUSF} based on the authentication method indicated by the authentication method indicator. If the verification passes, the UE may derive K_{AUSF} based on the authentication method indicated by the authentication method indicator. Specifically, in a case that 5G AKA authentication method is used, the UE may calculate K_{AUSF} based on CK and IK of the UE (with CK and IK retrieved from USIM of the UE). In a case that EAP-AKA′ authentication method is used, the UE may derive CK′ and IK′ from CK and IK, respectively, and then calculate K_{AUSF} based on CK′ and IK′. The UE may then derive K_{AKMA}, and A-KID, for example, in a similar way as in step 9. The UE may further derive K_{AF}, for example, in a similar way as in step 11. The UE may store K_{AKMA}, A-KID and K_{AF} of the UE, for example, in an AKMA security context (or AKMA security association, e.g., an association of the A-KID and the K_{AF}).

### Step 16

Once the UE updates its security configuration, the UE may acknowledge to the AF. The acknowledgement may serve as a trigger for the AF to start a timer associated with the K_{AF}. The duration of the timer may be set to the lifetime of the K_{AF}. An expiration of the timer indicates the expiration of the K_{AF}.

Optionally, after the UE updates its security configuration, such as the K_{AUSF}, the UE may notify the UDM about the successful update, and the UDM may correspondingly store or refresh the AUSF instance associated with the UE.

### Embodiment 6: Key Refresh without NEF-Conditional AKMA Security Context Request

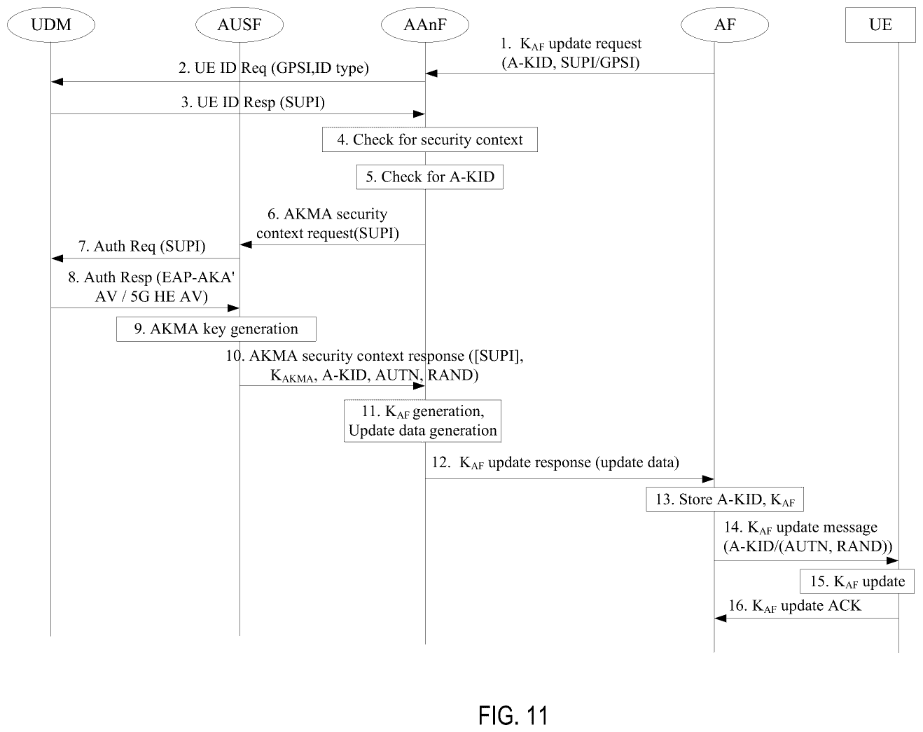

FIG. 11 shows exemplary steps for the AF to refresh security configuration including K_{AF} associated with a UE. The refresh is further synchronized to the UE.

In this embodiment, the AF may have direct access to the core network. Therefore, there is no need to use an NEF as a relay to the core network. Alternatively, the NEF may be co-located with the AAnF. In this case, the existence of the NEF may be transparent to the AF.

In this embodiment, additional factors are considered by the AAnF. To at least save signaling overhead and reduce network element interactions, the AAnF may check if a valid security context associated with the UE is locally available. If the security context is available, then the AAnF may not need to interact with core network elements such as AUSF and/or UDM to solicit UE security context. This check performed by the AAnf may further help reducing signaling overhead in later steps, as less data may need to be transmitted via signaling.

With reference to FIG. 11, the exemplary steps are described in details below.

### Step 0

Step 0 is optional and is not shown in FIG. 11. In this step, the UE successfully performs a primary authentication with the core network and the UE is configured with valid security context.

### Step 1

The K_{AF} in the AF is expired or invalid, or the K_{AF} may be lost under a faulty condition. In order to refresh the K_{AF}, the AF may send a K_{AF} update request to the AAnF. The K_{AF} update request may include the A-KID of the UE. The K_{AF} update request may further include the identity of the UE, e.g., GPSI, SUPI, or 5G-GUTI of the UE. If SUPI is used in the request, step 2 and step 3 below may be skipped

### Steps 2-3

Upon receiving the K_{AF} update request message from the AF in step 1, if the identity of the UE in the request message is in the form of GPSI or another format other than SUPI, the AAnF may retrieve the SUPI of the UE from the UDM. In particular, the AAnF may send to the UDM a UE ID request which may include the GPSI and optionally an ID type indicator. The ID type indicator may indicate the ID type for the ID requested. For example, the ID type indicator may indicate the ID in the form of SUPI is requested. The UDM may reply with the SUPI of the UE in a UE ID response message in step 3.

### Step 4

Based on the SUPI carried in K_{AF} update request message, the AAnF may check if there is UE security context (e.g., AKMA security context) configured (or provisioned, stored) in the AAnF corresponding to the SUPI. For example, the AAnF may check if an K_{AKMA} corresponding to the SUPI exists.

In case that the UE security context corresponding to the SUPI is not configured, step 5 below may be skipped. Otherwise, step 5 is performed.

### Step 5

The AAnF may compare the A-KID received from the K_{AF} update request message with the A-KID in the UE security context which is configured (or provisioned, stored) in the AAnF. If the two A-KIDs are different, then steps 6-10 below may be skipped. This scenario may happen when the UE just performs a successful primary authentication in step 0. If the two A-KIDs are the same, then step 6 is performed.

### Step 6

The AAnF may then select an AUSF based on its local policy and send an AKMA Security Context Request to the selected AUSF. The AKMA Security Context Request may include the SUPI of the UE.

In one implementation, the AAnF may be provisioned with AUSF function, or the AAnF and the AUSF may be co-located. In this case, the AAnF may directly interact with the UDM to request the AKMA Security Context from the UDM.

### Step 7

Upon receiving the AKMA Security Context Request from the AAnF, the AUSF may send an Authentication Request to the UDM. The Authentication Request may be used to request the AKMA security context and may include the SUPI of the UE.

### Step 8

The UDM (or ARPF) may determine the authentication method according to the UE subscription data of the UE. In one implementation, the UDM may retrieve the UE subscription data based on the SUPI of the UE.

If the authentication method is EAP-AKA′, the UDM may reply to the AUSF with an EAP-AKA′ Authentication Vector (AV). The EAP-AKA′ AV may include at least one of:
a random number (RAND), which may be used as a challenge;
an authentication token (AUTN), which may be used for proving the challenge's freshness and authenticity;
an expected response (XRES) to the challenge in an authentication procedure;
a transformation of the cipher key of the UE (transformed key denoted as CK′); or
a transformation of the integrity key of the UE (transformed key denoted as IK′).

The transformation of the cipher key and the integrity key may be based on a predetermined algorithm, such as a KDF.

If the authentication method is 5G AKA, the UDM may reply to the AUSF with a 5G Home Environment Authentication Vector (5G HE AV). The 5G HE AV may include at least one of:
a random number (RAND), which may be used as a challenge;
an authentication token (AUTN), which may be used for proving the challenge's freshness and authenticity;
an expected response (XRES*) to the challenge in an authentication procedure;
an AUSF key (K_{AUSF}) of the UE.

The reply message to the AUSF may further include an authentication method indicator, which indicates what authentication method is chosen for the UE (e.g., 5G AKA, EAP-AKA′, or EAP-TLS).

In one implementation, the reply message to the AUSF may further include a Routing Indicator (RID) of the UE.

### Step 9

Upon receiving the response from the UDM, depending on the authentication method, the AUSF may retrieve the AUSF key (K_{AUSF}) from the response message directly, or may need to derive or generate K_{AUSF}.

If the authentication method indicator indicates that EAP-AKA′ is used as the authentication method, the AUSF may derive K_{AUSF} based on CK′ and IK′.

If the authentication method indicator indicates that 5G AKA is used as the authentication method, the AUSF may retrieve K_{AUSF} from the response message directly. For example, K_{AUSF} may be part of the 5G HE AV.

Next, the AUSF may generate the AKMA Anchor Key (K_{AKMA}) and the A-KID based on K_{AUSF}.

In one implementation, K_{AKMA} may be derived by: K_{AKMA}=KDF (SUPI, K_{AUSF}). KDF refers to an exemplary Key Derivation Function. For example, the KDF may include HMAC-SHA-256 (256-bit Hash-based Message Authentication Code for Secure Hash Algorithm). When using HMAC-SHA-256, the output of the KDF may be a 256-bits key. In one implementation, the output key may further be truncated, for example, to 128 bits. When deriving K_{AKMA} using KDF as described above, SUPI of the UE may be used as a key, and K_{AUSF} may be used as an input.

As described above, A-KID may be used to identify K_{AKMA} of the UE. In one implementation, A-KID may be represented in a Network Access Identifier (NAI) format, i.e. username@realm. The username part may include the RID of the UE and an AKMA Temporary UE Identifier (A-TID) of the UE, and the realm part may include Home Network Identifier of the UE. In one implementation, A-TID may be derived based on K_{AUSF} using a KDF. For example, A-TID=KDF (K_{AUSF}, “AKMA”), i.e., the KDF uses string “AKMA” as the input, and K_{AUSF} as the key. The RID may be received from the UDM as part of the response message in step 8.

In one implementation, K_{AKMA} or A-KID derived in this step may be served as part of the AKMA context of the UE, which is described in detail in steps below.

### Step 10

As a response to the AKMA Security Context Request received from the AAnF in step 6, the AUSF may send a reply message to the AAnF. The reply message may include at least one of:
the random number (RAND) from the EAP-AKA′ AV or the 5G HE AV, depending on the selected authentication method;
an authentication token (AUTN) from the EAP-AKA′ AV or the 5G HE AV, depending on the selected authentication method;
the authentication method indicator; or
the AKMA context of the UE.

The AKMA context of the UE may include K_{AKMA} of the UE and A-KID identifying K_{AKMA}.

In one implementation, the reply message may further include the SUPI of the UE.

### Step 11

Upon receiving the AKMA context response message from the AUSF, the AAnF may derive the Application Key (K_{AF}) of the UE from K_{AKMA} of the UE. For example, the application key may be determined by K_{AF}=KDF (AF-ID, K_{AKMA}), where AF-ID is the identifier of the AF.

The AAnF may also generate or prepare updated (i.e., currently valid) security data to be sent to the AF in step below. The updated security data may have different content in different cases.

### Case A

In case A, the two A-KIDs as described in step 5 are different. The updated security data may include:
A-KID identifying the K_{AKMA} of the UE.
K_{AF} of the UE corresponding to the AF;
a lifetime of the AKMA security context related configuration information, e.g., a valid time period for the security key such as K_{AF}.

### Case B

In case B, the UE security context corresponding to the SUPI is not configured in the AAnF in step 4, or the two A-KIDs as described in step 5 are the same. The updated security data may include:
A-KID identifying the K_{AKMA} of the UE;
K_{AF} of the UE corresponding to the AF;
a lifetime of the AKMA security context related configuration information, e.g., a valid time period for the security key such as K_{AF};
the random number (RAND) from the EAP-AKA′ AV or the 5G HE AV, which is received by the AAnF in the step 10;
an authentication token (AUTN) from the EAP-AKA′ AV or the 5G HE AV, which is received by the AAnF in the step 10; or
the authentication method indicator.

### Step 12

Once the updated security data is generated or derived, the AAnF may send the updated security data to the AF, for example, via a K_{AF} update response message, which is a response message to the K_{AF} update request message in step 1.

### Step 13

Based on the response message received in step 12, the AF may store A-KID and K_{AF} of the UE, as well as other security configuration information as seen in the updated security data described above.

### Step 14

To ensure UE to be in sync with the AF with regard to security configuration, the AF may send to the UE a K_{AF} update message may carry the security configuration. Based on different cases as described above, the security configuration may include different content:

### Case A

A-KID identifying the K_{AKMA} of the UE.

### Case B

the random number (RAND) from the EAP-AKA′ AV or the 5G HE AV;
an authentication token (AUTN) from the EAP-AKA′ AV or the 5G HE AV; or
the authentication method indicator.

The K_{AF} update message may trigger the UE to update its security configuration.

### Step 15

Once receives the K_{AF} update message from the AF, the UE may update its security configuration, which may include various keys and/or key identifiers.

### Case A

In this case, the UE may have performed a successful primary authentication, for example, in step 0. The UE may derive its K_{AF} based on the A-KID received from the K_{AF} update message, along with security context from the primary authentication.

### Case B

In this case, the UE may first verify the freshness and integrity of the received security configuration, for example, by checking the AUTN received. The AUTN may include a Sequence Number (SQN), and Message Authentication Code (MAC). If the MAC and SQN are successfully verified, the UE derives K_{AUSF} based on the authentication method indicated by the authentication method indicator. If the verification passes, the UE may derive K_{AUSF} based on the authentication method indicated by the authentication method indicator. Specifically, in a case that 5G AKA authentication method is used, the UE may calculate K_{AUSF} based on CK and IK of the UE (with CK and IK retrieved from USIM of the UE). In a case that EAP-AKA′ authentication method is used, the UE may derive CK′ and IK′ from CK and IK, respectively, and then calculate K_{AUSF} based on CK′ and IK′. The UE may then derive K_{AKMA}, and A-KID, for example, in a similar way as in step 9. The UE may further derive K_{AF}, for example, in a similar way as in step 11. The UE may store K_{AKMA}, A-KID and K_{AF} of the UE, for example, in an AKMA security context (or AKMA security association, e.g., an association of the A-KID and the K_{AF}).

### Step 16

Once the UE updates its security configuration, the UE may acknowledge to the AF. The acknowledgement may serve as a trigger for the AF to start a timer associated with the K_{AF}. The duration of the timer may be set to the lifetime of the K_{AF}. An expiration of the timer indicates the expiration of the K_{AF}.

Optionally, after the UE updates its security configuration, such as the K_{AUSF}, the UE may notify the UDM about the successful update, and the UDM may correspondingly store or refresh the AUSF instance associated with the UE.

### Embodiment 7: AKMA Push to UE

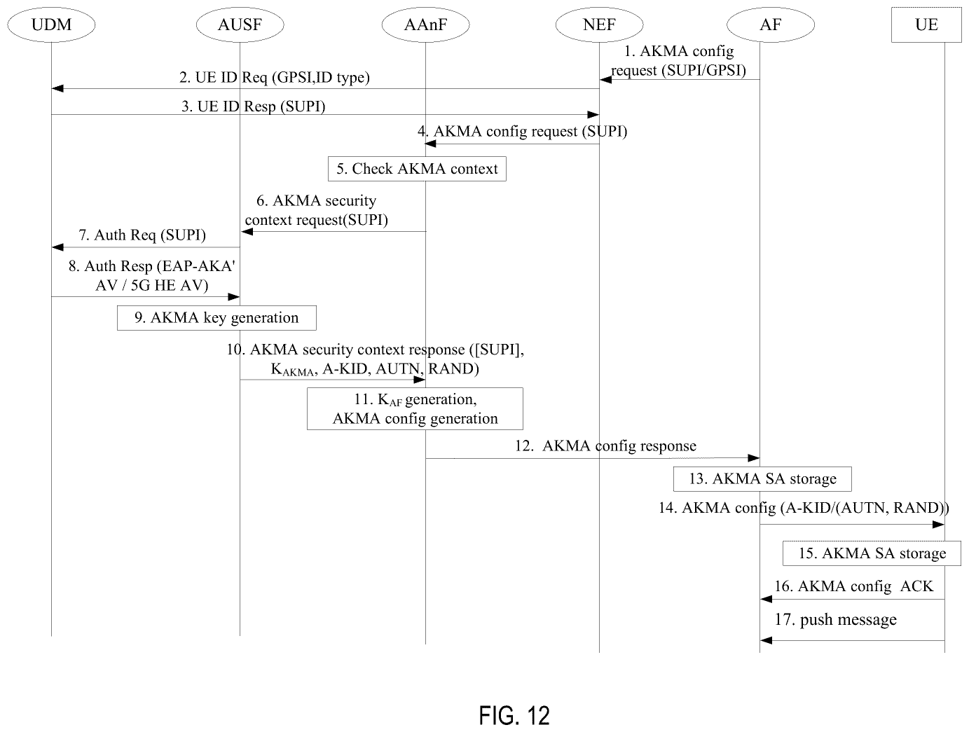

FIG. 12 shows exemplary steps for configuring AKMA security context on the AF and the UE. In this embodiment, the UE may have subscribed an application service from the AF, and the identity of the UE is known to the AF. The AF may proactively push security configuration to the UE, for example, if there is pending security configuration update. The exemplary steps are described in details below.

### Step 1

In order to push messages securely to the UE, a security context (may also be referred to as a security configuration, an AKMA security context) may be set up on both the Application Function (AF) side and the UE side. For example, the security context may be based on the AKMA framework and may include an AKMA anchor key (or an ID of the AKMA anchor key (A-KID)) of the UE, and an AF key of the UE. Alternatively, the security context may include a binding of the AKMA anchor key (or A-KID) of the UE and the AF key of the UE. This binding may be referred to as a Security Association (SA). As described earlier, in this disclosure, the AKMA anchor key of the UE and the AF key of the UE may be denoted as K_{AKMA} and K_{AF}, respectively.

To obtain the security context, the AF may send a push request (or AKMA config request) to the NEF, to request security context related configuration information. The request may include identity of the UE, e.g., GPSI, 5G-GUTI, or SUPI of the UE. In one implementation, the GPSI may be used when the AF is located outside the operator's network. Both GPSI and SUPI may be used when the AF is located inside the operator's network. In one implementation, the request may further include the AF ID (i.e., the identifier of the AF).

In one implementation, the AF may have a direct access to the core network. For example, the AF may have a direct access to the AAnF. In this case, the AF may send the request message directly to the core network.

In one implementation, the AF may already have an A-KID of the UE and a valid AF key (K_{AF}) of the UE available. In this case, the AF may directly jump to step 13 below, and send the A-KID directly to the UE, so the UE may establish the security association (SA) and/or store the security context.

### Steps 2-3

Upon receiving the push request from the AF in step 1, if the identity of the UE in the request message is in the form of GPSI or another format other than SUPI, the NEF may retrieve the SUPI of the UE from the UDM. In particular, the NEF may send to the UDM a UE ID request which may include the GPSI and optionally an ID type indicator. The ID type indicator may indicate the ID type for the ID requested. For example, the ID type indicator may indicate the ID in the form of SUPI is requested. The UDM may reply with the SUPI of the UE in a UE ID response message in step 3.

If the identity of the UE in the push request message is already in the form of SUPI, then steps 2-3 may be skipped.

### Step 4

The NEF sends the AKMA push request to the to the AAnF. The AKMA push request may include the SUPI of the UE.

### Step 5

Based on the SUPI of the UE, the AAnF may check if a corresponding AKMA security context of the UE (SUPI, K_{AKMA} and/or A-KID) exists locally in the AAnF. In case that the AAnF already has the AKMA context, steps 6-10 below may be skipped.

### Step 6

In step 5 above, the AAnF may determine that the AKMA security context for the UE is not available. The AAnF may then select an AUSF based on its local policy and forward an AKMA Security Context Request to the selected AUSF. The AKMA Security Context Request may include the SUPI of the UE.

In one implementation, the AAnF may be provisioned with AUSF function, or the AAnF and the AUSF may be co-located. In this case, the AAnF may directly interact with the UDM to request the AKMA Security Context Request from the UDM.

### Step 7

Upon receiving the AKMA Security Context Request from the AAnF, the AUSF may send an Authentication Request to the UDM. The Authentication Request may be used to request the AKMA security context and may include the SUPI of the UE.

### Step 8

The UDM may determine the authentication method according to the UE subscription data of the UE. In one implementation, the UDM may retrieve the UE subscription data based on the SUPI of the UE.

If the authentication method is EAP-AKA′, the UDM may reply to the AUSF with an EAP-AKA′ Authentication Vector (AV). The EAP-AKA′ AV may include at least one of:
a random number (RAND), which may be used as a challenge;
an authentication token (AUTN), which may be used for proving the challenge's freshness and authenticity;
an expected response (XRES) to the challenge in an authentication procedure;
a transformation of the cipher key of the UE (transformed key denoted as CK′); or
a transformation of the integrity key of the UE (transformed key denoted as IK′).

The transformation of the cipher key and the integrity key may be based on a predetermined algorithm, such as a KDF.

If the authentication method is 5G AKA, the UDM may reply to the AUSF with a 5G Home Environment Authentication Vector (5G HE AV). The 5G HE AV may include at least one of:
a random number (RAND), which may be used as a challenge;
an authentication token (AUTN), which may be used for proving the challenge's freshness and authenticity;
an expected response (XRES*) to the challenge in an authentication procedure;
an AUSF key (K_{AUSF}) of the UE.

The reply message to the AUSF may further include an authentication method indicator, which indicates what authentication method is chosen (e.g., 5G AKA, EAP-AKA′, or EAP-TLS).

In one implementation, the reply message to the AUSF may further include a Routing Indicator (RID) of the UE.

### Step 9

Upon receiving the response from the UDM, depending on the authentication method, the AUSF may retrieve the AUSF key (K_{AUSF}) from the response message directly, or may need to derive or generate K_{AUSF}.

If the authentication method indicator indicates that EAP-AKA′ is used as the authentication method, the AUSF may derive K_{AUSF} based on CK′ and IK′.

If the authentication method indicator indicates that 5G AKA is used as the authentication method, the AUSF may retrieve K_{AUSF} from the response message directly.

Next, the AUSF may generate the AKMA Anchor Key (K_{AKMA}) and the A-KID based on K_{AUSF}.

In one implementation, K_{AKMA} may be derived by: K_{AKMA}=KDF (SUPI, K_{AUSF}). KDF refers to Key Derivation Function. For example, the KDF may include HMAC-SHA-256 (256-bit Hash-based Message Authentication Code for Secure Hash Algorithm). When using HMAC-SHA-256, the output of the KDF may be a 256-bits key. In one implementation, the output key may further be truncated, for example, to 128 bits. When deriving K_{AKMA} using KDF as described above, SUPI of the UE may be used as a key, and K_{AUSF} may be used as an input.

As described above, A-KID may be used to identify K_{AKMA} of the UE. In one implementation, A-KID may be represented in a Network Access Identifier (NAI) format, i.e. username@realm. The username part may include the RID of the UE and an AKMA Temporary UE Identifier (A-TID) of the UE, and the realm part may include Home Network Identifier of the UE. In one implementation, A-TID may be derived based on K_{AUSF} using a KDF. For example, A-TID=KDF (K_{AUSF}, “AKMA”), i.e., the KDF uses string “AKMA” as the input, and K_{AUSF} as the key. The RID may be received from the UDM as part of the response message in step 8.

In one implementation, K_{AKMA} or A-KID derived in this step may be served as part of the AKMA context of the UE, which is describe in detail in steps below.

### Step 10

As a response to the AKMA Security Context Request received from the AAnF in step 4, the AUSF may send a reply message to the AAnF. The reply message may include at least one of:
the random number (RAND) from the EAP-AKA′ AV or the 5G HE AV, depending on the selected authentication method as indicated in step 8;
an authentication token (AUTN) from the EAP-AKA′ AV or the 5G HE AV;
the authentication method indicator; or
the AKMA context of the UE.

The AKMA context of the UE may include K_{AKMA} of the UE and A-KID identifying K_{AKMA}.

In one implementation, the reply message may further include the SUPI of the UE.

### Step 11

Upon receiving the AKMA context response message from the AUSF, the AAnF may derive the Application Key (K_{AF}) of the UE from K_{AKMA} of the UE. For example, the application key may be determined by K_{AF}=KDF (AF-ID, K_{AKMA}), where AF-ID is the identifier of the AF.

Based on the response from the AUSF, the AAnF may be able to derive the AKMA security context related configuration information for the UE and the AF.

In one implementation, the AAnF may not have the AKMA context of the UE in step 5. In this case, the AAnF may generate or derive the AKMA security context related configuration information which may include:
A-KID identifying the K_{AKMA} of the UE;
K_{AF} of the UE corresponding to the AF;
a lifetime of the AKMA security context related configuration information, e.g., a valid time period for the security key such as K_{AF};
the random number (RAND) from the EAP-AKA′ AV or the 5G HE AV;
an authentication token (AUTN) from the EAP-AKA′ AV or the 5G HE AV, which is received by the AAnF in the step 10; or
the authentication method indicator.

In one implementation, in step 5, the AAnF may already have the AKMA context of the UE. In this case, step 6 to step 10 may be skipped. The AAnF may generate the AKMA security context related configuration information which may include:
A-KID identifying the K_{AKMA} of the UE;
K_{AF} of the UE; or
a lifetime of the AKMA security context related configuration information, e.g., a valid time period for the security key such as K_{AF}.

### Step 12

Once the AKMA security context related configuration information is generated or derived, the AAnF may send the AKMA security context related configuration information to the AF, as a response to step 4 (essentially step 1).

### Step 13

Based on the response message received in step 10, the AF may store A-KID and K_{AF} of the UE in an AKMA security context (or AKMA security association, i.e., the association of the A-KID and the K_{AF}).

### Step 14

The AF may forward the AKMA security context related configuration information to the UE.

In one implementation, the AAnF does not have the AKMA context of the UE in step 5. In this case, the AKMA security context related configuration information may include at least one of:
the random number (RAND) from the EAP-AKA′ AV or the 5G HE AV;
an authentication token (AUTN) from the EAP-AKA′ AV or the 5G HE AV; or
the authentication method indicator.

In one implementation, in step 5, the AAnF may already have the AKMA context of the UE. In this case, the AKMA security context related configuration information may include A-KID identifying the K_{AKMA} of the UE.

### Step 15

Once receives the AKMA security context related configuration information from the AF, the UE may store A-KID and K_{AF} in an AKMA security context (or AKMA security association, i.e., the association of the A-KID and the K_{AF}).

In one implementation, the AAnF does not have the AKMA context of the UE in step 5 (this condition may be implied by the received AKMA security context related configuration information, e.g., by determining that A-KID does not present). In this case, the UE may first verify the freshness and integrity of the received AKMA security context related configuration information, for example, by checking the received AUTN. If the verification passes, the UE may derive K_{AUSF} based on the authentication method indicated by the authentication method indicator. Specifically, in a case that 5G AKA authentication method is used, the UE may calculate K_{AUSF} based on CK and IK of the UE (with CK and IK retrieved from USIM of the UE). In a case that EAP-AKA′ authentication method is used, the UE may derive CK′ and IK′ from CK and IK, respectively, and then calculate K_{AUSF} based on CK′ and IK′. The UE may then derive K_{AKMA}, and A-KID in a similar way as in step 9. The UE may further derive K_{AF} in a similar way as in step 11. The UE may store A-KID and K_{AF} of the UE in an AKMA security context (or AKMA security association, i.e., the association of the A-KID and the K_{AF}).

In one implementation, in step 5, the AAnF may already have the AKMA context of the UE (this condition may similarly be implied by the received AKMA security context related configuration information, e.g., by determining that A-KID does present). In this case, the UE may compare the received A-KID with an A-KID locally stored by the UE. If there is a match, the UE may look up the K_{AF} corresponding to the AF which may be stored locally in the UE, and proceed to storing A-KID and K_{AF} of the UE in an AKMA security context (or AKMA security association, i.e., the association of the A-KID and the K_{AF}).

### Step 16

Once the UE stores the AKMA security context or establishes the AKMA security association, the UE may acknowledge to the AF. The acknowledgement may serve as a trigger for the AF to start a timer associated with the K_{AF}. The duration of the timer may be set to the lifetime of the K_{AF}. An expiration of the timer indicates the expiration of the K_{AF}.

Optionally, after the UE updates AKMA security context or establishes the AKMA security association, the UE may notify the UDM about the successful update, and the UDM may correspondingly store or refresh the AUSF instance associated with the UE.

### Step 17

Till this step, the UE and the AF may have each established the AKMA security association or have stored the AKMA security context. The AF may push message securely to the UE based on the AKMA security context.

In this disclosure, various embodiments are disclosed for updating/refreshing security configuration in various network entities such as AF, and UE. An AF may detect a security configuration to be expired, lost, or out of sync with the other network elements. Various mechanisms are described for the AF to refresh its security configuration and synchronize the security configuration update to the UE. In exemplary embodiments, the AAnF may further check if a valid UE security context is locally configured in the AAnF, via various approaches. Based on the check result, the AAnF may bypass procedures for soliciting UE security context from the core network thus saving signaling overhead and improving efficiency.

In this disclosure, the steps in each embodiment are for illustration purposes only and other alternatives may be derived based on the disclosed embodiments as desired. For example, only part of the steps may need to be performed. For another example, the sequence of the steps may be adjusted. For another example, several steps may be combined (e.g., several messages may be combined in one message). For yet another example, a single step may be split (e.g., one message may be sent via two sub-messages).

The accompanying drawings and description above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1-7. (canceled)

8. A method for wireless communication, performed by a first network element in a wireless network, the first network element hosting an Authentication and Key Management for Applications (AKMA) anchor function, and the method comprising:
receiving a first message requesting updated security related information associated with a wireless device in the wireless network, the first message comprising at least one of:
an identifier of the wireless device; or
a first AKMA anchor key identifier associated with the wireless device;
deriving a currently valid AKMA application key based on a currently valid AKMA anchor key associated with the wireless device;
obtaining updated security related information associated with the wireless device based on at least the currently valid AKMA application key; and
transmitting, to a second network element hosting an application function, a second message as a response to the first message, the second message comprising the updated security related information associated with the wireless device.

9. The method of claim 8, wherein the updated security related information comprises at least one of:
an AKMA anchor key identifier identifying the currently valid AKMA anchor key associated with the wireless device;
the currently valid AKMA application key associated with the wireless device;
an AKMA application key lifetime associated with the currently valid AKMA application key; or
a set of security configuration parameters associated with the wireless device comprising at least one of:
an authentication method indicator indicating an authentication method; or
authentication parameters corresponding to the authentication method.

10. The method of claim 8, wherein receiving the first message comprises:
receiving, from the second network element, the first message requesting the updated security related information associated with the wireless device, the first message comprising at least one of:
the identifier of the wireless device comprising one of: a GPSI of the wireless device, or a SUPI of the wireless device; or
the first AKMA anchor key identifier associated with the wireless device.

11. The method of claim 8, wherein:
receiving the first message comprises:
receiving, from a third network element hosting a network exposure function, the first message requesting the updated security related information associated the wireless device, the first message comprising at least one of:
the identifier of the wireless device comprising one of: a GPSI, or a SUPI; or
the first AKMA anchor key identifier associated with the wireless device; and
the first message is triggered by the third network element receiving a third message from the second network element, the third message requesting the updated security related information associated with the wireless device, wherein the third message comprises at least one of:
the GPSI of the wireless device;
the SUPI of the wireless device; or
the first AKMA anchor key identifier associated with the wireless device.

12. The method of claim 8, wherein before deriving the currently valid AKMA application key based on the currently valid AKMA anchor key associated with the wireless device, the method further comprises:
transmitting, to a fourth network element hosting an AUSF, a fourth message requesting security configuration associated with the wireless device, the fourth message comprising the identifier of the wireless device;
receiving, from the fourth network element, a fifth message as a response to the fourth message, the fifth message comprising the security configuration associated with the wireless device, wherein the security configuration comprises at least one of:
an authentication method indicator indicating an authentication method;
authentication parameters corresponding to the authentication method;
an AKMA security context comprising at least one of:
the currently valid AKMA anchor key associated with the wireless device; or
a second AKMA anchor key identifier identifying the currently valid AKMA anchor key; or
a SUPI of the wireless device.

13. The method of claim 12, wherein:
in response to the authentication method indicator indicating an EAP-AKA′ method as the authentication method, the authentication parameters comprise a random number and an authentication token; and
in response to the authentication method indicator indicating a 5G-AKA method as the authentication method, the authentication parameters comprise a 5G HE AV.

14. The method of claim 12, wherein:
before transmitting the fourth message to the fourth network element, the method further comprises:
determining whether the first AKMA anchor key identifier is configured in the first network element; and
in response to the first AKMA anchor key identifier not being configured in the first network element, determining, based on the identifier of the wireless device, whether a security context associated with the wireless device is configured in the first network element; and
transmitting, to the fourth network element, the fourth message requesting the security configuration associated with the wireless device comprises:
in response to the security context associated with the wireless device not being configured in the first network element, transmitting, to the fourth network element, the fourth message requesting the security configuration associated with the wireless device comprises, the fourth message comprising the SUPI of the wireless device.

15. The method of claim 14, wherein, in response to the first AKMA anchor key identifier not being configured in the first network element and the security context associated with the wireless device being configured in the first network element, the updated security related information associated with the wireless device comprises at least one of:
an AKMA anchor key identifier from the security context associated with the wireless device configured in the first network element, the AKMA anchor key identifier identifying the currently valid AKMA anchor key;
the currently valid AKMA application key associated with the wireless device; or
an AKMA application key lifetime associated with the currently valid AKMA application key.

16. The method of claim 15, wherein:
a reception of the second message by the second network element triggers the second network element to transmit a target security related information to the wireless device, the target security related information being based on the updated security related information; and
a reception of the target security related information by the wireless device triggers the wireless device to update a target security configuration based on the target security related information, the target security configuration comprising a target AKMA anchor key identifier corresponding to the second network element.

17. The method of claim 12, wherein, in response to the first AKMA anchor key identifier being configured in the first network element, or in response to the AKMA security context associated with the wireless device not being configured in the first network element, the updated security related information associated with the wireless device comprises at least one of:
the second AKMA anchor key identifier;
the currently valid AKMA application key associated with the wireless device;
an AKMA application key lifetime associated with the currently valid AKMA application key;
the authentication method indicator indicating the authentication method; or
the authentication parameters corresponding to the authentication method.

18. The method of claim 12, wherein:
before transmitting the fourth message to the fourth network element, the method further comprises:
determining, based on the identifier of the wireless device, whether a security context associated with the wireless device is configured in the first network element; and
in response to the security context associated with the wireless device being configured in the first network element, determining whether the first AKMA anchor key identifier is the same as an AKMA anchor key identifier in the security context; and
transmitting, to the fourth network element, the fourth message requesting the security configuration associated with the wireless device comprises:
in response to the first AKMA anchor key identifier being the same as the AKMA anchor key identifier in the security context, transmitting, to the fourth network element, the fourth message requesting the security configuration associated with the wireless device comprises, the fourth message comprising the SUPI of the wireless device.

19. The method of claim 18, wherein the updated security related information associated with the wireless device is characterized by at least one of:
in response to the first AKMA anchor key identifier being different the AKMA anchor key identifier in the security context, the updated security related information associated with the wireless device comprising at least one of:
the first AKMA anchor key identifier associated with the wireless device;
the currently valid AKMA application key associated with the wireless device; or
an AKMA application key lifetime associated with the currently valid AKMA application key; or
in response to the first AKMA anchor key identifier being the same as the AKMA anchor key identifier in the security context, or in response to the security context associated with the wireless device not being configured in the first network element, the updated security related information associated with the wireless device comprising at least one of:
the second AKMA anchor key identifier;
the currently valid AKMA application key associated with the wireless device;
an AKMA application key lifetime associated with the currently valid AKMA application key;
the authentication method indicator indicating an authentication method; or
the authentication parameters corresponding to the authentication method.

20. (canceled)

21. A method for wireless communication, performed by a first network element in a wireless network, the first network element hosting an application function, and the method comprising:
transmitting a first message requesting updated security related information associated with a wireless device in the wireless network, the first message comprising at least one of:
an identifier of the wireless device; or
a first AKMA anchor key identifier associated with the wireless device; and
receiving, from a second network element hosting an AKMA anchor function, a second message as a response to the first message, the second message comprising the updated security related information associated with the wireless device.

22. The method of claim 21, wherein the updated security related information comprises at least one of:
a currently valid AKMA anchor key identifier associated with the wireless device;
a currently valid AKMA application key associated with the wireless device;
an AKMA application key lifetime associated with the currently valid AKMA application key; or
a set of security configuration parameters associated with the wireless device comprising at least one of:
an authentication method indicator indicating an authentication method; or
authentication parameters corresponding to the authentication method.

23. The method of claim 22, further comprising:
updating security configuration of the first network element based on the updated security related information, the security configuration of the first network element comprising at least one of:
an AKMA application key associated with the wireless device; or
an AKMA anchor key identifier associated with the wireless device.

24. The method of claim 22, further comprising:
transmitting, to the wireless device, a third message comprising a target security related information, the target security related information being based on the updated security related information, wherein a reception of the target security related information by the wireless device triggers the wireless device to derive and update a security configuration comprising at least one of:
an AKMA anchor key identifier associated with the wireless device;
an AKMA anchor key associated with the wireless device; or
an AKMA application key corresponding to the first network element; and
receiving, from the wireless device, a fourth message as a response to the third message, the fourth message acknowledging a successful update on the security configuration of the wireless device.

25. (canceled)

26. The method of claim 21, wherein transmitting the first message comprises:
transmitting, to the second network element, the first message requesting the updated security related information associated with the wireless device, the first message comprising at least one of:
the identifier of the wireless device comprising one of: a GPSI of the wireless device, or a SUPI of the wireless device; or
the first AKMA anchor key identifier associated with the wireless device.

27. The method of claim 26, wherein the updated security related information associated with the wireless device is characterized by at least one of:
in response to the second network element being configured with a currently valid security context associated with the wireless device upon receiving the first message, the updated security related information comprising at least one of:
the first AKMA anchor key identifier associated with the wireless device;
an AKMA anchor key identifier from the currently valid security context associated with the wireless device;
a currently valid AKMA application key associated with the wireless device; or
an AKMA application key lifetime associated with the currently valid AKMA application key; or
in response to the second network element not being configured with a currently valid security context of the wireless device upon receiving the first message, the updated security related information comprising at least one of:
a currently valid AKMA application key associated with the wireless device;
an AKMA application key lifetime associated with the currently valid AKMA application key; or
a set of security configuration parameters associated with the wireless device received from a third network element, the set of security configuration parameters comprising at least one of:
a second AKMA anchor key identifier associated with the wireless device;
an authentication method indicator indicating an authentication method; or
authentication parameters corresponding to the authentication method.

28-31. (canceled)

32. A first network element comprising a memory for storing computer instructions and a processor in communication with the memory, the first network element hosting an Authentication and Key Management for Applications (AKMA) anchor function, wherein, when the processor executes the computer instructions, the processor is configured to cause the first network element to:
receive a first message requesting updated security related information associated with a wireless device, the first message comprising at least one of:
an identifier of the wireless device; or
a first AKMA anchor key identifier associated with the wireless device;
derive a currently valid AKMA application key based on a currently valid AKMA anchor key associated with the wireless device;
obtain updated security related information associated with the wireless device based on at least the currently valid AKMA application key; and
transmit, to a second network element hosting an application function, a second message as a response to the first message, the second message comprising the updated security related information associated with the wireless device.

33. A device comprising a memory for storing computer instructions and a processor in communication with the memory, wherein the processor, when executing the computer instructions, is configured to implement a method in claim 21.
